(19) United States
(12) Patent Application Publication
(10) Pub. No.: US 2011/0028331 A1
(43) Pub. Date: Feb. 3, 2011

(54) DETECTION OF MUTATIONS IN ACTA2 AND MYH11 FOR ASSESSING RISK OF VASCULAR DISEASE

(75) Inventors: Dianna M. Milewicz, Houston, TX (US); Dongchuan Guo, Pearland, TX (US); Hariyadarshi Pannu, Houston, TX (US); Van Tran Fadulu, Manvel, TX (US)

Correspondence Address: CONLEY ROSE, P.C.;David A. Rose, P. O. BOX 3267, HOUSTON, TX, 77253-3267, US

(73) Assignee: BOARD OF REGENTS OF THE UNIVERSITY OF TEXAS SYSTEM, Austin, TX (US)

(21) Appl. No.: 12/679,770

(22) PCT Filed: Sep. 24, 2008
(86) PCT No.: PCT/US08/77515

§ 371 Date: Aug. 30, 2010

Related U.S. Application Data
(60) Provisional application No. 60/974,684, filed on Sep. 24, 2007.

(51) Int. Cl. C40B 30/00

(52) U.S. Cl. 506/7

(57) ABSTRACT

A method of detecting in an individual an increased risk of hyperplastic vasculomyopathy, or a vascular disease resulting therefrom is disclosed. The method comprises obtaining a DNA genome sample from the individual and detecting in the sample a missense mutation in a gene which is a component of a smooth muscle cell contractile unit. In some embodiments the gene is ACTA2 and in some embodiments the gene is MYH11. In some embodiments, the gene is sequenced and then compared to a panel of control gene sequences which are representative of the same gene in individuals without vascular disease or who are at low risk of developing hyperplastic vasculomyopathy, to detect any missense mutations in the gene. The presence of a missense mutation in the gene indicates an increased risk of hyperplastic vasculomyopathy.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Grant Nos. RO1 HL62594 and P50 HL083794-01 awarded by the National Heart, Lung, and Blood Institute (NHLBI) of the National Institutes of Health.

### BACKGROUND OF THE INVENTION

1. Technical Field

The present invention generally relates to methods for diagnosing vascular disease or for assessing an individual's risk of developing a vascular disease. More particularly, the invention relates to such methods which include screening for certain mutations in vascular smooth muscle cell α-actin and/or β-myocin genes.

2. Description of Related Art

Actins constitute a family of highly-conserved (>97% identity) cytoskeletal proteins that are indispensable for cellular function. All vertebrates encode six tissue-specific actin isoforms: two in striated-muscle (skeletal (ACTA1) and cardiac (ACTC)), two in smooth-muscle cells (SMCs) (vascular (ACTA2) and visceral (ACTG2)), and two in non-muscle cells (ACTB and ACTG1)^{1, 2}. The differentiated SMC expresses a unique repertoire of contractile proteins, and ACTA2 is the single most abundant protein in SMCs, accounting for 40% of the total cellular protein and 70% of the total actin³. The ACTA2 null mouse demonstrates that ACTA2 is not required for formation of the cardiovascular system, perhaps because the ectopic expression of skeletal ACTA1 in aortic SMCs compensates for the loss of ACTA2⁴. However, despite the increase in ACTA1, compromised vascular contractility, tone, and blood flow were detected in the ACTA2-deficient mice, suggesting that ACTA2 deficiency leads to impaired vascular SMC contractility.

The first evidence that mutations in a SMC contractile protein cause familial thoracic aortic aneurysms leading to acute aortic dissections (TAAD) was provided by the identification of MYH11 mutations as a rare cause of familial TAAD associated with patent ductus arteriosus (PDA)^{5, 6}. TAAD results from diverse etiologies, including infectious agents, hemodynamic forces, and genetic syndromes, but studies have established that at least 20% of patients have a genetic predisposition for TAAD inherited primarily in an autosomal dominant manner with decreased penetrance and variable expression⁷⁻⁹. Two loci and two genes have been identified for familial TAAD, TAAD1 at 5q13-14, FAA1 at 11q23.2024, TGFBR2 and MYH11^{7, 10}.

### BRIEF SUMMARY

In accordance with certain embodiments of the invention, a method of detecting in an individual an increased risk of hyperplastic vasculomyopathy, or a vascular disease resulting therefrom, is provided. The method comprises obtaining a DNA genome sample from the individual; determining in the sample the sequence of a gene which is a component of a smooth muscle cell contractile unit; and comparing the sequence to a panel of control gene sequences that are representative of the same gene in individuals without vascular disease or who are at low risk of developing hyperplastic vasculomyopathy, to detect any missense mutations in the gene, wherein the presence of at least one missense mutation in the gene indicates an increased risk of hyperplastic vasculomyopathy in the individual. A “missense mutation” is a point mutation that in which a single nucleotide is changed to cause substitution of a different amino acid. In some embodiments the gene is α-actin (ACTA2). In some embodiments one or more missense mutation is N117T, R149C, R258H, R258C, T353N, R118Q, Y135H, V154A, R292G, R29H, P72Q, G160D, R185Q, R212Q, P245H, 1250L, or T326N or a combination of any of those. In some embodiments the gene is β-myosin heavy chain (MYH11).

In some embodiments, the hyperplastic vasculomyopathy or vascular disease resulting therefrom is stroke, myocardial infarcts, aortic aneurysms and dissections, peripheral vascular disease, peripheral neuropathy, bicuspid aortic value, patent ductus arteriosus, cardiac arrhythmias, Sneddon's syndrome, or Moyamoya disease, or a combination of any of those diseases. In some embodiments the hyperplastic vasculomyopathy or vascular disease comprises thoracic aortic aneurysms and dissections (TAAD). These and other embodiments, features and advantages of the present invention will be apparent with reference to the following description and drawings.

### BRIEF DESCRIPTION OF THE DRAWINGS

FIG. 1. Identification of ACTA2 as the causative gene responsible for TAAD and LR in family TAA327. (a) Pedigree of family TAA327 with the legend indicating the disease and mutation status of the family members. The current age of family members is shown in years and “d” indicates age at death. A single asterisk indicates individuals whose DNA was used in the 50K GeneChips SNP array assay. Two asterisks indicate individuals who were not examined for livedo reticularis (LR). (b) Illustration of marked LR on the leg of individual TAA327:II:17. An alteration in a plasma protein leading to a hypercoagulable state had been excluded as the cause of LR in this individual. (c) Parametric multipoint logarithm of odds (LOD) score profile for TAAD across the human genome in family TAA327 based on the Affymetrix 50K GeneChips Hind array data. Human chromosomes are concatenated from p-terminal (left) to q-terminal (right) on the x-axis. The parametric LOD score is on the y-axis and is correlated to physical location of human chromosome on the x-axis. Two candidate loci on chromosome 10 and chromosome 17 were identified with a parametric multipoint LOD score over 1.8 for TAAD. (d) Three-point linkage analysis of microsatellite marker data at the chromosome 10 and 17 loci for TAAD and LR in the TAA327 family confirms linkage of TAAD and LR to chromosome 10 markers. The y-axis shows LOD scores and the x-axis shows position of the markers based on their relative chromosomal distance.

FIG. 2. Clinical characteristics and familial segregation of ACTA2 mutations in patients with familial TAAD. FIG. 2A: (a) Four families with the recurrent ACTA2 R149C mutation. The brief description of FIG. 1, above, describes the clinical and mutation status of the family members. Individuals who were noted to have iris flocculi are indicated with the ̂ symbol. (b) Families with vascular disease due to ACTA2 R258 mutation. Family members with documented cerebral aneurysms are indicated by a # symbol. FIG. 2B: (c) Additional families with novel ACTA2 mutations as indicated. Spontaneous abortions are designated by a triangle.

FIG. 3. Amino acid substitutions identified in ACTA2 in patients with familial TAAD. (a) A schematic of the intron and exon structure of the ACTA2 gene is presented, along with the location of ACTA2 mutations found in the families. The light colored boxes represent the exons in ACTA2 and the darker boxes represent the 3′ and 5′ untranslated regions. (b) The highly conserved orthologous protein sequences of ACTA2 across multiple species are illustrated and the dark shaded blocks indicate the location of ACTA2 mutations.

FIG. 4 shows the impact of ACTA2 mutation on ACTA2 protein structure and function. (a) Location of ACTA2 mutations are mapped onto the crystal structure of actin (PDB ID: 1J6Z). The surface representation of two actin monomers is illustrated within the context of the newly refined actin filament model¹¹. The surface (heavy solid arrow) (bottom subunit) comprises the DNase I binding region, which adopts a helical conformation in monomeric ADP-actin¹². Indicated by heavy dashed arrows is the barbed end surface (comprising residues Y135 to A137; L144 to T150; Y168 to Y171; 1343 to M357) that directly interacts with numerous actin binding proteins (ABP) as well as several regulatory proteins. R149C and T353N (indicated by black asterisks (*)), as well as Y135H (not visible in this orientation) all localize to the hydrophobic cleft between subdomains 1 and 3. These mutations are expected to not only impede the actin—ABP interaction, but also actin—actin contacts. (b) Ribbon diagram of the actin backbone. C^{α} atoms of the mutated residues (at positions 292, 154, 149, 118, 117, 258, 363, 135) are shown as spheres. The hydrophobic cleft is located in between sub-domains 1 (SD1) and 3 (SD3). Spheres marked with white asterisks (*) represent mutations (N117T and R258H) that are common to both ACTA1¹³ and ACTA2 (as shown in this study). Residue numbering is in accordance with the rules of Human Genome Variation Society (www.genomic.unimelb.edu.au/mdi/mutnomen/). (c) Immunofluorescence analysis of stress fibers in cultured SMCs from a control and two patients with ACTA2 mutations. In the control cells, extensive co-localization of ACTA2 (green fluorescence indicated by bright fluorescence in the “ACTA2” panels) and polymerized actin (stained red with phalloidin) (indicated by bright fluorescence in the “All filamentous actin” panels) was observed. In contrast, the patients' SMCs showed greatly diminished ACTA2, with significantly fewer polymerized actin fibers that did not extend completely across the cell body. 400× magnification, scale bar=40 μM. The merged panels show that in the control SMCs, the actin stress filaments contain ACTA2, whereas in the patients' SMCs the actin filaments do not contain ACTA2.

FIG. 5. Aortic pathology associated with ACTA2 mutations. (A) Movat staining and ACTA2 immunostaining of aortic media from a control and two patients with ACTA2 mutations. Medial degeneration characterized by proteoglycan accumulation (stained blue/indicated by light areas), loss and fragmentation of elastic fibers (stained black, portions of which are indicated by solid black or white arrows), no collagen accumulation (stained yellow), and areas of SMC loss was present in patients' aortas compared with control aorta. ACTA2 staining of SMCs in the media demonstrated the SMC disarray in the patients' aortas. (B) H&E and ACTA2 immunostaining of the vasa vasorum from one control and two patients with ACTA2 mutations. Normal vessels were present in the control while the patients' vasa vasorum exhibited increased size and fibromuscular dysplasia (FMD) due to SMC hyperplasia in some of the adventitial vessels. ACTA2 staining of the vasa vasorum confirmed that the FMD in patients was due to SMC hyperplasia and the hyperplasia was absent in the control. Magnification is indicated on each set of panels. Scale bar=100 μM

FIG. 6. Clinical features of patients with ACTA2 mutations are shown. (a) illustrates livedo reticularis on the feet and legs of the following TAA327 family members: IV:10 (upper left); IV:4 (upper right panel); III:13 (lower left); and III:8 (lower middle). The LR on the leg of individual III:8 was still clearly visible even with warming in the sun when the ambient temperature was 27° C. (80° F.) (lower right). (b) Iris flocculi present in family TAA349 are illustrated. Iris flocculi are seen as excrescences of the iris pigmentary epithelium at the pupillary margin in II:3 (upper left), III:4 (upper right) and III:5 (lower right) with anterior segment slit-lamp biomicroscopy. In individual II:3 the iris flocculi were cystic in nature as demonstrated by high resolution anterior segment non-contact optical coherence tomography (Visante™, Carl Zeiss Meditec, Inc.) (lower left), where the cornea is shown (indicated by arrow) with cystic iris lesions protruding into the anterior chamber from the iris pupillary margin. (c) Survival curve for the time to death using a Kaplan-Meier estimate for ACTA2 mutation positive family members. There was no significant difference in time to death between men and women (p=0.498). The median survival is 67 years.

FIG. 7. Identification of ACTA2 mutation in patients with TAAD from TAA327 and constructing disease-associated microsatellite haplotypes on TAAD families with R149C mutation. (a) Heterozygous 492→T substitution in ACTA2, altering R149C, present in an affected TAA327 family member and absent in a normal person (wild type). (b) The locations of ACTA2 and surrounding microsatellite markers in chromosome 10. (c) Disease-associated microsatellite haplotypes in the TAAD families with R149C mutation. The mutation-linked allele of D10S1735 in TAA041 could not be determined because of the limited pedigree size.

FIG. 8. Aortic pathology associated with ACTA2 mutations. Assessment of immunofluorescence at lower magnification confirms diminished stress fibers of ACTA2 mutant SMCs compared with control SMCs³⁴. The control SMCs uniformly demonstrated abundant stress fibers across the cell body with co-localization of ACTA2 (green) and polymerized actin (red). Green fluorescence is indicated by the bright fluorescence in the “All filamentous actin” panels. Red fluorescence is indicated by the bright fluorescence in the “SM α-actin” panels. All patients' SMCs exhibited significantly diminished ACTA2-containing fibers compared with control SMCs. In addition, the ACTA2 staining did not co-localize with polymerized actin fibers. In SMCs from patient TAA 174:II:6 the ACTA2 staining was perinuclear in an unpolymerized pool and SMCs from patient TAA313:II:2 has ACTA2 fibers only at the periphery of the cell, along with large aggregates of ACTA2. The patients' SMCs were also noted to be smaller than control SMCs. 200× magnification, scale bar=50 μM.

FIG. 9. First panel (a) shows cell proliferation assays (BrdU incorporation) of SMCs explanted from patients heterozygous for an ACTA2 mutation (n=2) proliferate more rapidly than matched control SMCs (n=2). Second panel (b) illustrates that myofibroblasts (fibroblasts exposed to TGF-β1 for 72 hours) from patients heterozygous for ACTA2 mutations (n=9) proliferate more rapidly than matched controls (n=10). Data are expressed as means±S.E.M and p values are indicated. Immunoblotting for SM α-actin from the cell lysates confirms that TGF-β1 exposure increased cellular SM α-actin.

### DETAILED DESCRIPTION

### Overview

The major function of vascular smooth muscle cells (SMCs) is contraction to regulate blood pressure and flow. SMC contractile force requires cyclic interactions between SMC α-actin (ACTA2) and β-myosin heavy chain (MYH11). Here it is shown that missense mutations in ACTA2 are responsible for 14% of inherited ascending thoracic aortic aneurysms and dissections (TAAD). Structural analyses and immunofluoresence of actin filaments in SMCs derived from patients heterozygous for ACTA2 mutations illustrate that these mutations interfere with actin filament assembly and are predicted to decrease SMC contraction. Aortic tissues from affected individuals showed aortic medial degeneration, focal areas of medial SMC hyperplasia and disarray, and stenotic arteries in the vasa vasorum due to medial SMC proliferation. These data, along with the previously reported MYH11 mutations causing familial TAAD1, illustrate the importance of SMC contraction in maintaining the structural integrity of the ascending aorta. Detection of mutations in ACTA2 and/or in MYH11 is used in the diagnosis of diffuse vascular disease and in assessing risk of developing diseases that can result from mutations in those genes. Early detection of such mutations in an individual allows for diagnosis and early treatment of such vascular diseases as thoracic aortic aneurysm, thoracic aortic dissections (TAAD) (ascending “type A” and descending dissections “type B”), coronary artery disease (CAD), Moyamoya disease, Sneddon's syndrome, livedo reticularis, peripheral neuropathy, cardiac arrhythmias and bicuspid aortic valve.

### Materials and Methods

Family characterization and sample collection. The Institutional Review Board at the University of Texas Health Science Center approved this study. Families with multiple members with TAAD who did not have a known genetic syndrome were recruited, characterized, and samples collected as previously described¹⁴. In brief, family members at risk for TAAD were imaged for the presence of asymptomatic ascending aneurysms. Individuals were considered affected if they had dissection of the thoracic aorta, surgical repair of an ascending aneurysm, or had dilatation of the ascending aorta greater than 2 standard deviations based on echocardiography images of the aortic diameter at the sinuses of Valsalva, the supra-aortic ridge, and the ascending aorta when compared with nomograms derived from normal individuals' measurements³¹. Medical records pertaining to all cardiovascular disease were collected on family members. Blood or buccal cells for DNA were collected. Collection of aortic tissue followed previously described methods³². Paraffin-embedded aortic specimens were available from six ACTA2 mutations patients, TAA327:III:19 and IV:5, TAA105:II:4, TAA166:II:2, TAA313:II:2 and TAA174:II:6. SMCs were explanted from aortic tissue from TAA313:II:2 and TAA174:II:6. Control DNA was obtained from Caucasians with no history of cardiovascular disease.

Linkage analysis. Samples of genomic DNA from seven members of family TAA327 were analyzed on 50K GeneChips Hind array from Affymetrix with the manufacturer's protocol. For the fine mapping, linkage analysis was performed with microsatellite markers on 27 family members (Table 5). Primers and map locations were based on the GDB Human Genome Database (http://www.gdb.org) and the UCSC genome browser (http://genome.ucsc.edu). The fluorescently labeled PCR products were generated with a universal fluorescently labeled primer set following published protocols¹⁰. The amplified products were analyzed on an ABI Prism 3130×1 Genetic Analyzer; Genemapper 4.0 software assigned the allele distribution (Applied Biosystems).

Sequencing and genotyping. Mutational analysis of genes was performed by bidirectional direct sequencing of amplified genomic DNA fragments with intron-based, exon-specific primers (Tables 2 and 3). Sequencing and genotyping protocols have been described previously¹⁴. The controls were sequenced at the Baylor Human Genome Center and the sequencing protocol, in brief, is as follows: PCR reactions were performed in 8 μl containing 10 ng of genomic DNA, 0.4 μM oligonucleotide primers, and 0.7× Qiagen® PCR Hot Start Master Mix containing buffer and polymerase. Cycling parameters were 95°—15 min., then 95°—45 sec., 60°—45 sec., and 72°—45 sec. for 40 cycles followed by a final extension at 72° for 7 minutes. After thermocycling, 5 μl of a 1:15 dilution of Exo-SAP was added to each well and incubated at 37° for 15 min. prior to inactivation at 80° for 15 minutes. Reactions were diluted by 0.6× and 2 μl were combined with 5 μl of 1/64^{th} Applied Biosystems® (AB) BigDye™ sequencing reaction mix and cycled as above for 25 cycles. Reactions were precipitated with ethanol, resuspended in 0.1 mM EDTA and loaded on AB 3730XL sequencing instruments using the Rapid36 run module and 3xx base-caller. SNPs were identified using SNP Detector software³³.

Statistical analysis. Multipoint linkage analyses of Affymetrix 50K SNP array data were performed with the Allegro program 2.0¹⁵. It was assumed an autosomal dominant model for TAAD with a disease-gene frequency of 0.00006 and a phenocopy rate of 0.001¹⁰. Four age-dependent liability classes were previously described¹⁰. Linkage analysis was also performed with cases affected by TAAD or LR or both coded as affected. The disease-allele frequency and penetrance were the same as used for TAAD; age of onset of LR was used for those affected with LR only. Multipoint non-parametric LOD (NPL) and parametric LOD scores were calculated by a sliding window of 180-200 SNPs within the Allegro program. Linkage analyses by microsatellite markers with extended pedigree was performed as previously described¹⁰. LR alone linkage analysis was performed only on family 327 with a dominant model and a single liability class with penetrance of 0.90 for risk genotypes and the same disease-allele frequency. A minor allele frequency for ACTA2 mutation was set at 0.001.

SMC cultures, histology and immunofluorescence studies. Aortic media from two ACTA2 mutation patients was separated and SMCs explanted in media to maintain differentiation as previously described¹⁶. Immunofluorescence of ACTA2 and polymerized filamentous actin (F-actin) was performed in cultured SMCs at passage 3. Image acquisition and deconvolution were performed as described previously¹⁷. 4′,6′-Diamidino-2-phenylinodole (DAPI) was used for the nuclei, Texas Red for phalloidin (binds to polymerized actin (F-actin)), and fluorescein isothiocyanate (FITC) tagged secondary antibody for SMC ACTA2. Mouse monoclonal SMC ACTA2 antibody from Sigma (A5228) was used for immunohistology. Hematoxylin-eosin and Movat's pentachrome stains were performed by standard procedures.

GenBank accession numbers. Homo sapiens chromosome 10, complete sequence: NC_{—}000010 ACTA2; Homo sapiens ACTA2 mRNA:NM_{—}001613. ACTA1, ACTC1 and ACTA2 amino acid numbering in this manuscript adheres to current Human Genome Variation Society nomenclature guidelines (http://www.hgvs.org/mutnomen/).

### EXPERIMENTAL

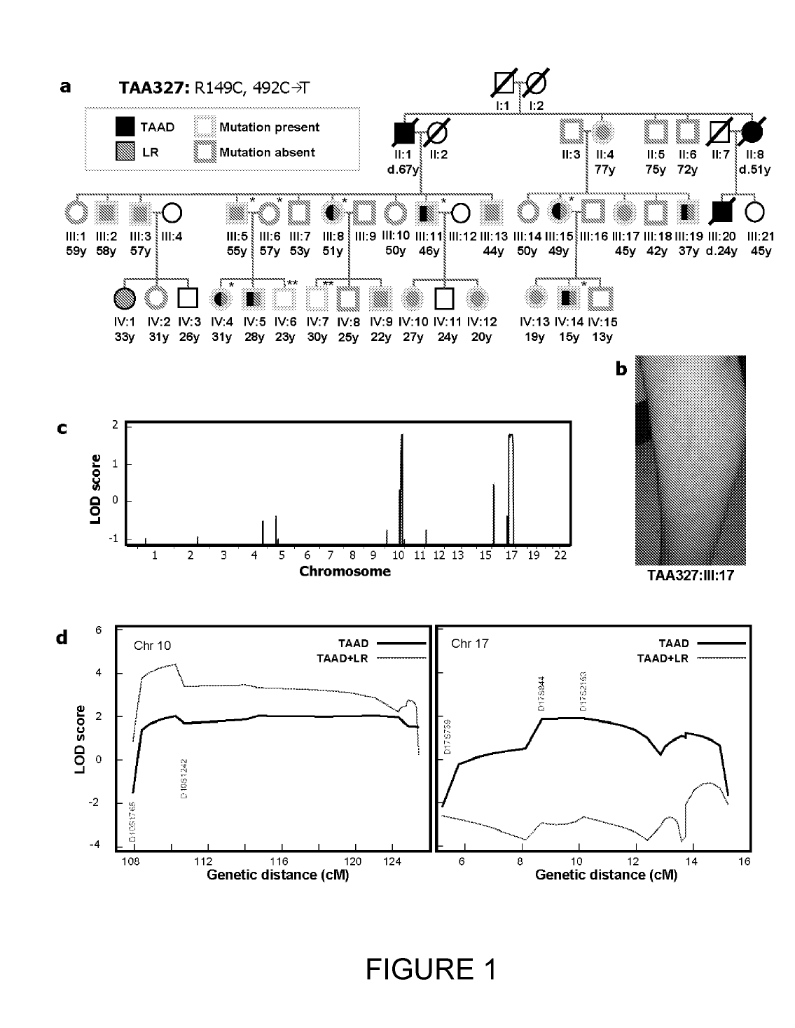

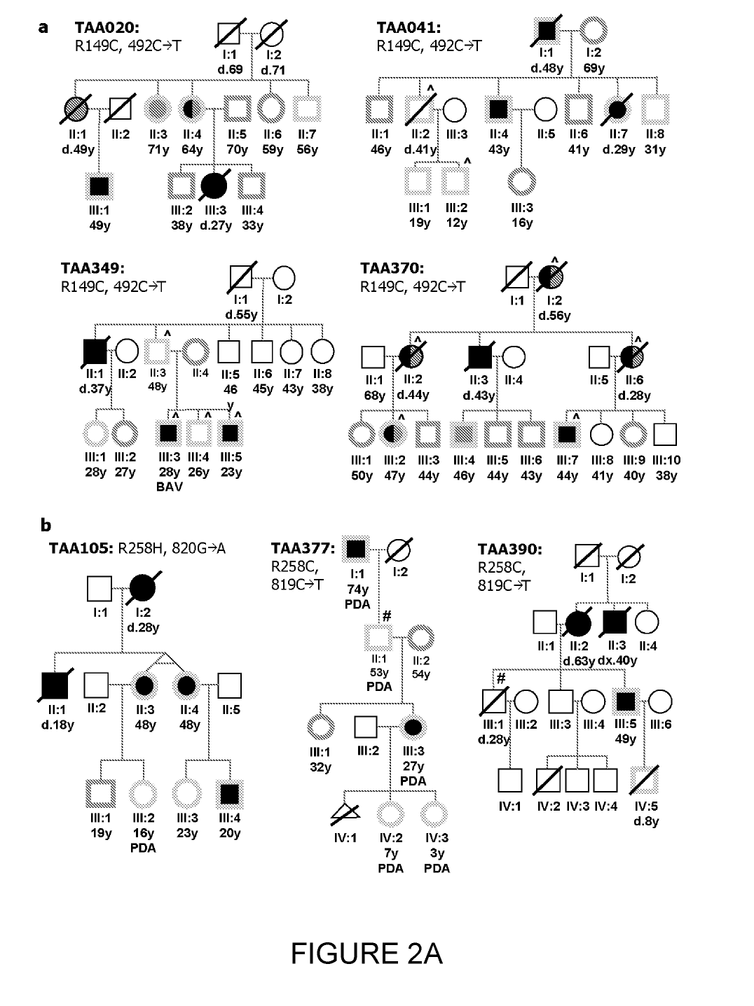

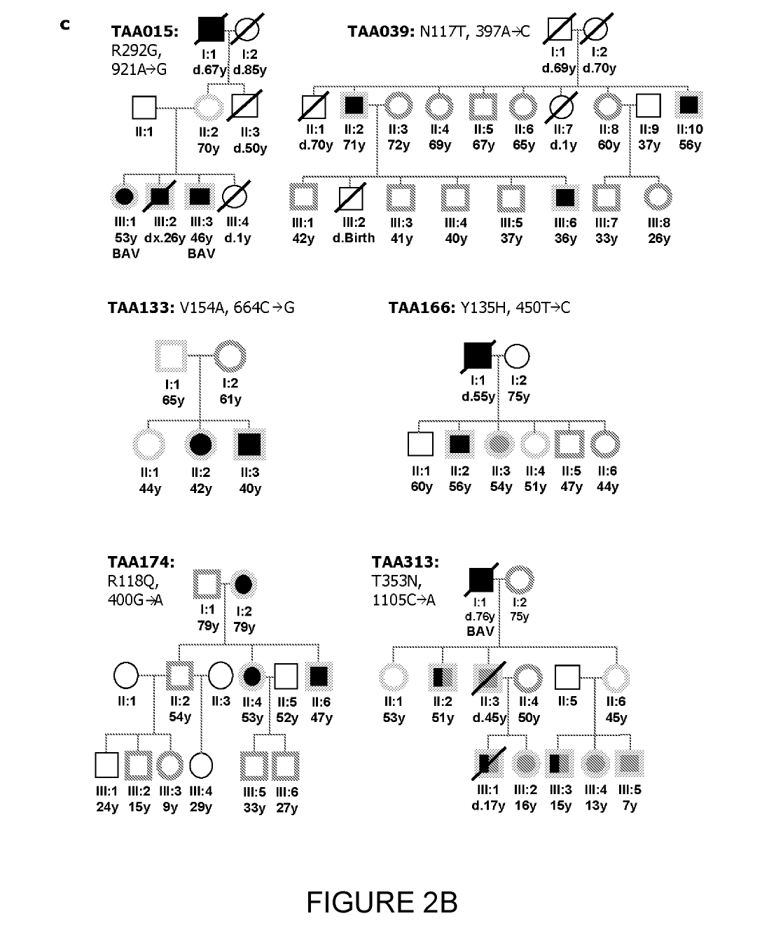

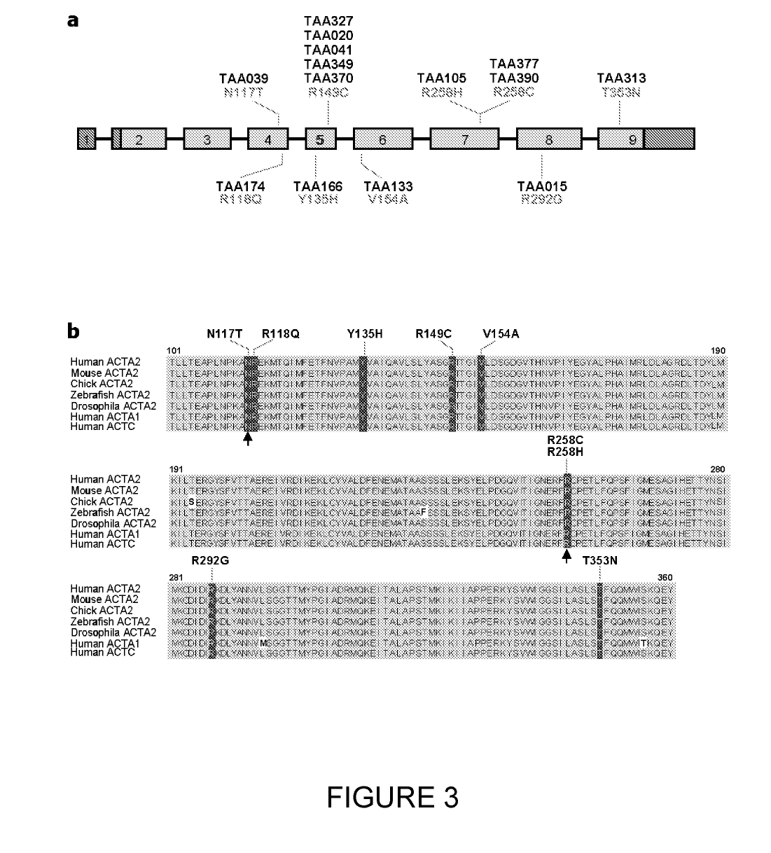

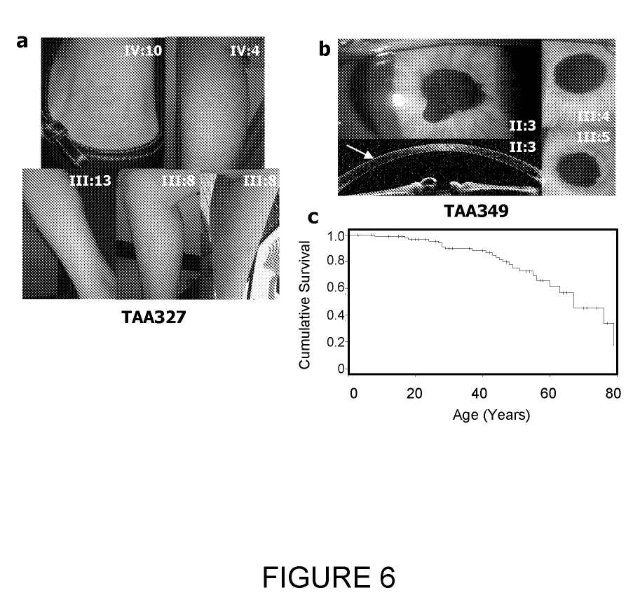

A large family, TAA327, with autosomal dominant inheritance of TAAD with decreased penetrance was identified, and it was verified that the segregation of disease was not linked to known TAAD loci. On examination, the only physical feature present in all family members with TAAD was pronounced and persistent livedo reticularis (LR) clearly visible on their arms and legs. LR is a purplish skin discoloration in a network pattern that is due to constriction or occlusion of deep dermal capillaries (FIG. 1(a),(b) and FIG. 6(a)). To map the gene causing TAAD associated with LR, genome-wide linkage analysis was performed on seven family members with TAAD with the Affymetrix 50K SNP array. Assuming an age-dependent model of penetrance, parametric multipoint LOD score analysis for the TAAD phenotype yielded peaks at 10q23-24 and 17p11-13 with LODₘₐₓ scores of 1.80 and 1.81, respectively (FIG. 1(c)). The significant LR in all individuals with TAAD, along with a previous publication linking TAAD and LR, suggested that LR may be a clinical marker for the disease gene prior to aortic disease¹⁸. The investigation proceeded to type 31 microsatellite markers on 10q and 17p in the DNA of 27 family members, and the data from TAAD and LR combined were analyze (FIG. 1(d) and Table 1). These analyses yielded a LODₘₐₓ=4.40 on chromosome 10q23-24 for TAAD and LR, therefore defining a new locus for familial TAAD associated with LR (TAAD4) and excluding the 17p locus. Recombinants delineated the critical genetic region to an interval of 17.2 Mb between D1051765 and D1051264, a gene-rich region. Twelve candidate genes in the interval were sequenced and analysis of ACTA2 revealed a missense mutation, R149C, which altered an invariant amino acid, segregated with the affected haplotype, and was absent from 384 healthy Caucasian control subjects (FIG. 2A(a) and Tables 2 and 3). The mutation segregated with LR in the family with a LOD score of 5.85. These results suggested that the R149C ACTA2 mutation was responsible for both TAAD and LR in TAA327.

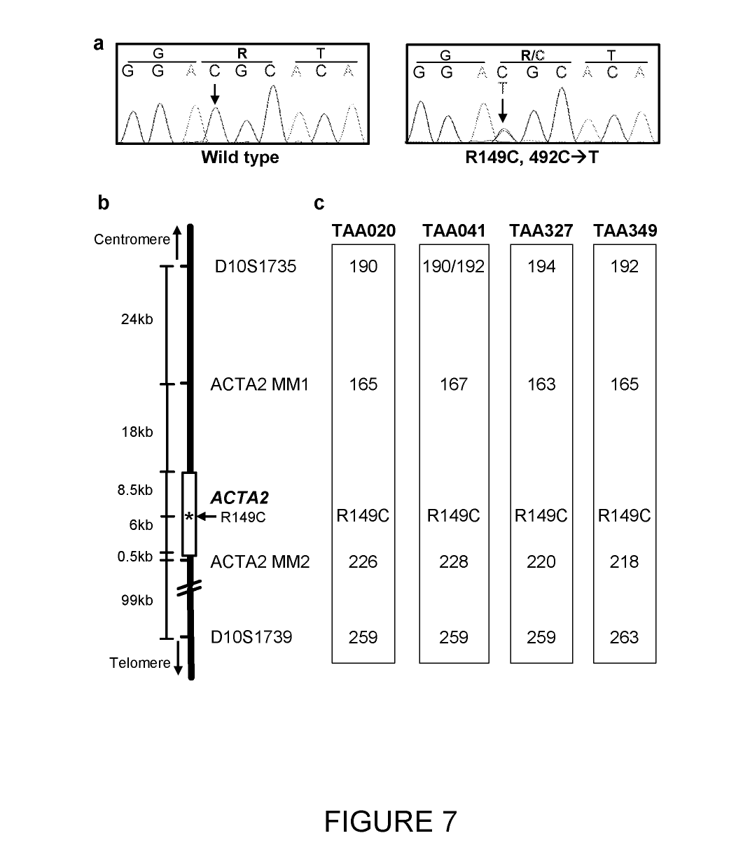

Sequencing of the ACTA2 gene in 97 unrelated TAAD families identified 14 additional families with ACTA2 mutations. All mutations segregated with TAAD and were absent in 192 controls. In fact, no variation in the gene was found in 384 unrelated control chromosomes. Four additional families with the ACTA2 R149C mutation (TAA020, TAA041, TAA349, and TAA370) were identified (FIG. 2A(a). However, each family had a unique haplotype, implying the mutations arose de novo in multiple families FIG. 7(a),(b). In addition, iris flocculi, an ocular abnormality previously described to be associated with TAAD and LR in family TAA370, segregated with the ACTA2 mutation in TAA349 and TAA370 FIG. 6(b)^{18, 19}.

Three Caucasian TAAD families had mutations altering 8258 to either a histidine or cysteine (FIG. 2A(b). All 5 affected members in family TAA377 and one individual in TAA105 had PDAs. The presence of PDAs in five individuals with ACTA2 mutations is not unexpected given that MYH11 mutations also lead to both TAAD and PDA. The remaining 6 families (5 Caucasian and 1 Filipino) had novel ACTA2 missense mutations (FIG. 2B(c) and 3). Three individuals in these families had bicuspid aortic valves. LR was noted in some affected individuals, but not all family members could be examined for this finding

The penetrance of TAAD in individuals with ACTA2 mutations was low (0.48) and did not increase with age, differing from other identified loci and genes for familial TAAD, which have a higher, age-related penetrance^{6, 10}. Despite the low penetrance, linkage analysis of TAAD with ACTA2 mutations revealed a LOD score of 4.17 in these 14 families, therefore firmly establishing ACTA2 mutations as a cause of familial TAAD. The majority of individuals presented with acute ascending (type A) or descending (type B) aortic dissections and 16 of the 24 deaths were due to type A dissections (Tables 4 and 5). Two individuals experienced type A dissections with documented ascending aortic diameters at 4.5 and 4.6 cm, whereas 11 individuals dissected at aortic diameters greater than 5.0 cm. Aortic dissections occurred in 3 individuals under 20 years of age and two women died of dissections post partum. Finally, three young men had type B dissection complicated by rupture or aneurysm formation at the ages of 13, 16 and 21 years. Despite the young age of death of some family members, the Kaplan-Meier survival curve of the ACTA2 cohort estimated a median survival of 67 years, suggesting that the disease was less deadly than Loeys-Dietz syndrome and similar to treated Marfan syndrome (FIG. 6(c))^{9, 20}.

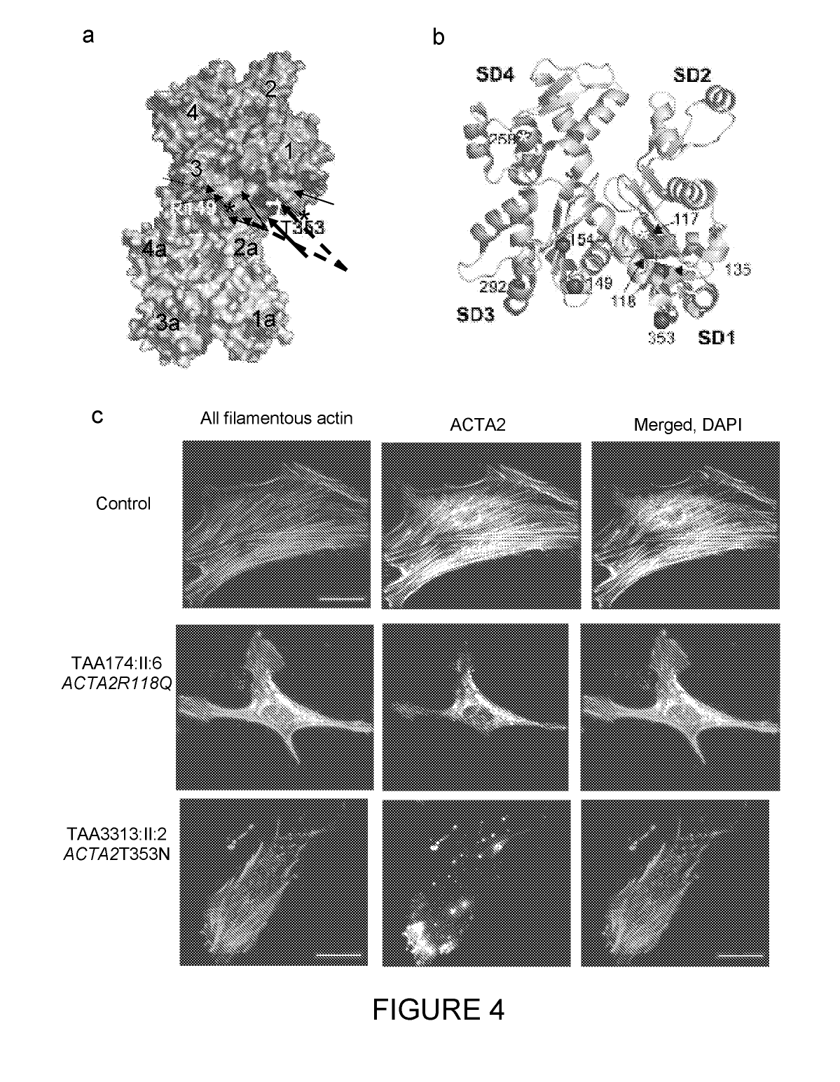

The molecular consequences of ACTA2 mutations can be explained by the structure of actin. Mutation of ACTA2 amino acids Y135, R149, or T353 perturbs the integrity of the hydrophobic cleft (FIG. 4(a),(b)), which serves as both the binding determinant of several regulatory proteins and the target of diverse marine macrolide toxins that permanently cap the barbed end and block protomer addition or removal^{21, 22}. Notably, the guanidinium side chain of R149 entertains hydrogen bonding interaction with P139 and N141 of DBP and T353 interacts with N17 of ciboulot. Therefore, mutations that alter the chemical or structural makeup of residues that comprise this vital binding region are expected to be deleterious. Analogously, R258H mutation can eliminate actin—nebulin interactions by disrupting the tertiary structure altogether. R292 is positioned near an area involved in polymer contacts in actin filaments. Therefore, removal of charge at this site may preclude interactions along and across the strands. N117 and R118 are buried and located outside the polymer contact area. However, they reside near the nucleotide binding cleft. Similarly, V154 is strategically placed in the “shear” region, which is involved in facilitating the opening and closing of the nucleotide binding cleft²³. Therefore, V154A is predicted to impinge upon the dynamics of actin assembly by interfering with ATP hydrolysis.

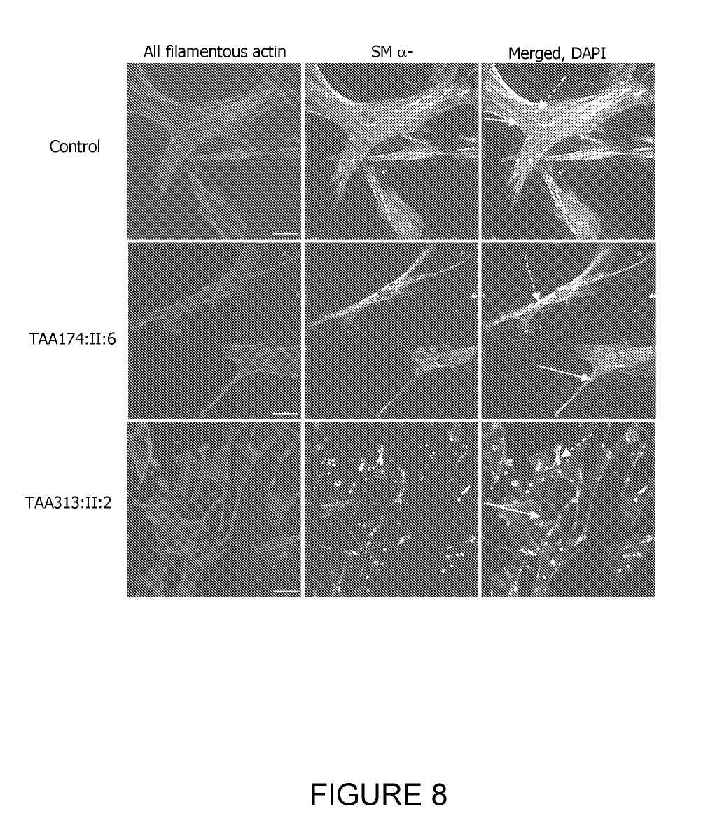

To test the structural predictions, ACTA2 filaments in aortic SMCs derived from two patients heterozygous for ACTA2 mutations were analyzed. ACTA2 is a major protein in the actin filaments of the contractile unit in vascular SMCs, while ACTB is found in the actin filaments of the cytoskeleton²⁴. Antibodies specific for ACTA2 were used; in addition, all cellular polymerized actin in filaments was visualized with phalloidin (FIG. 4(c) and FIG. 8). In control SMCs, ACTA2 was present in the abundant fibers extending across the cell and in a small pool of unpolymerized actin in the perinuclear region. In contrast, the SMCs from TAA174:II:6 (R118Q) had no ACTA2-containing filaments and an increased pool of unpolymerized actin. SMCs from TAA313:II:2 (T353N) had reduced ACTA2-containing fibers that were present only at the periphery of the cell, along with large aggregates of ACTA2. These observations suggest that both R118Q and T353N mutations perturb ACTA2 filament assembly or stability

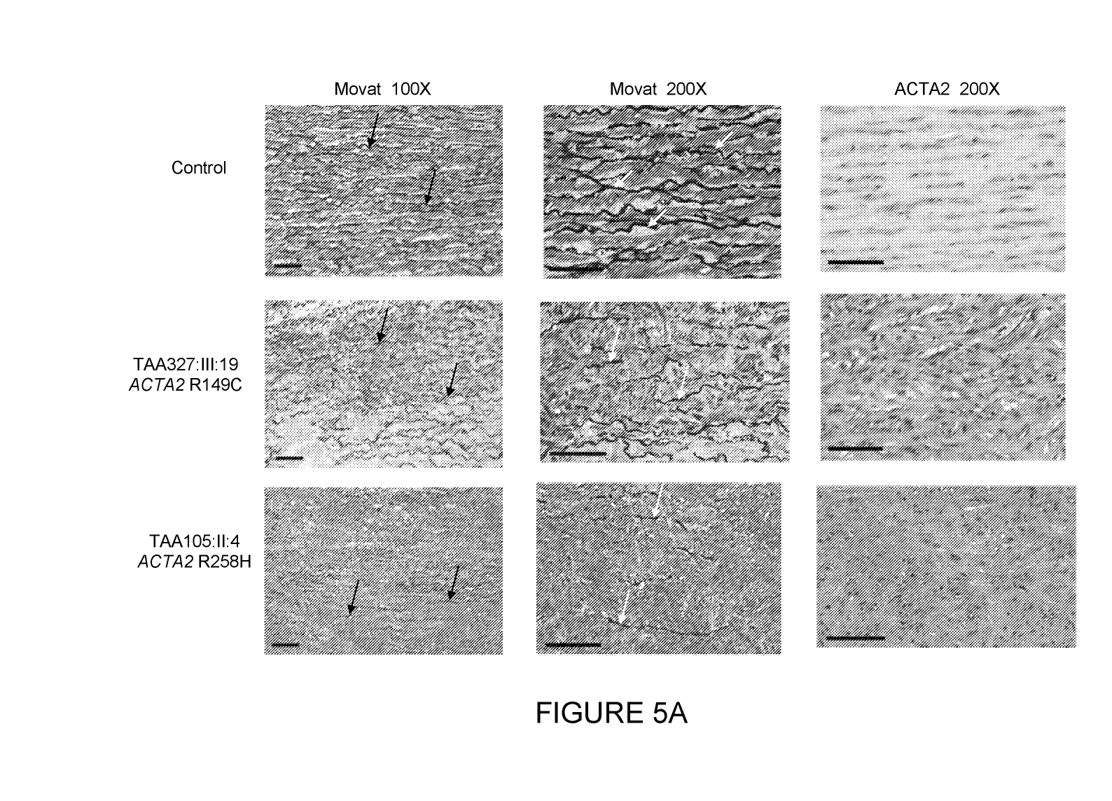

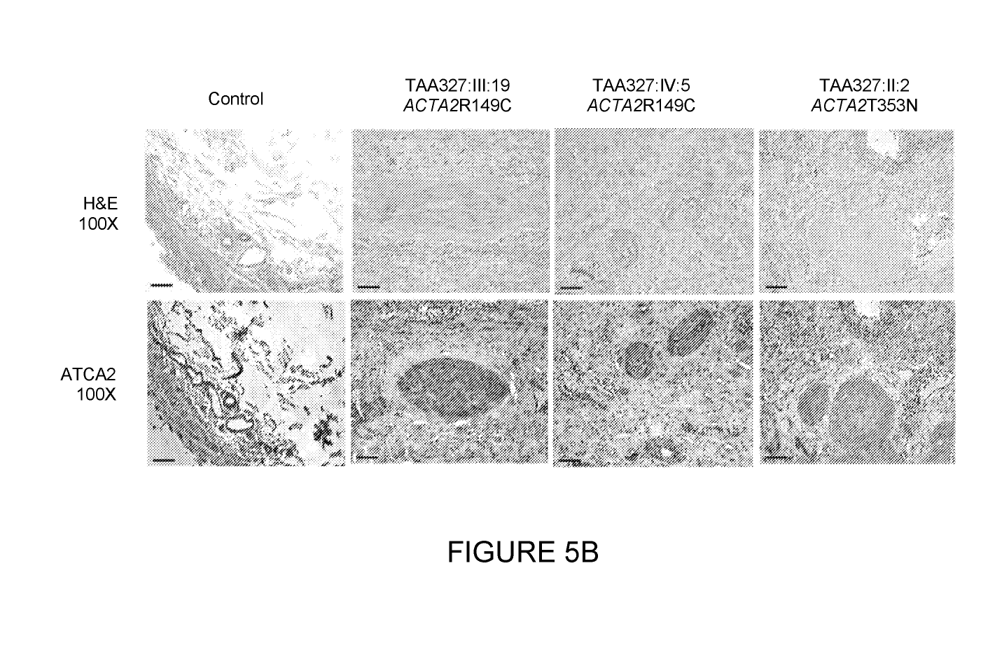

Analysis of the aortic tissue from 6 patients with ACTA2 mutations demonstrated increased proteoglycan accumulation, fragmentation and loss of elastic fibers, and decreased numbers of SMCs, findings typical of medial degeneration of the aorta (FIG. 5A). Atypical findings were focal areas of increased numbers of SMCs that were remarkable for a lack of structured orientation parallel to the lumen of the aorta. Instead, the SMCs were oriented randomly with respect to one another, reminiscent of myocyte disarray in HCM. The ACTA2 aortas were also notable for marked medial SMC proliferation leading to stenosis or occlusion of the vessel in focal areas of the vasa vasorum not present in control aortas and increase size of the vessels in the vasa vasorum compared to control (FIG. 5B). Similar aortic pathology was found in tissues derived from patients with MYH11 mutations⁶.

Unique mutations in ACTA2 gene in the noncoding regions were also identified in patients with vascular diseases (Table 6). A variant was identified in the 5'UTR of ACTA2 in 11 stroke patients, 10 of whom had premature onset of hemorrhagic strokes, and was not present in over 400 ethnically matched controls. This variant is predicted to affect the second structure of the 5′UTR of the ACTA2 message. Other variants in introns 2, 3 and 5 were identified in vascular disease patients but not in controls. In addition, alterations in the 3'UTR were identified in vascular disease patients that were not present in controls. These rare variants are predicted to lead to vascular diseases in patients based on the association of this number of variants in patients that are not present in controls.

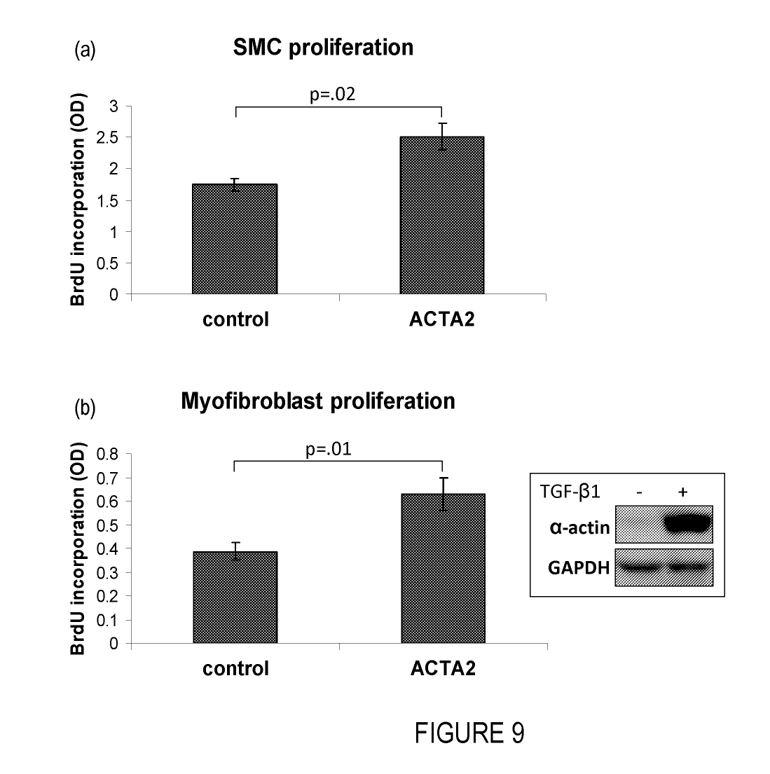

Panel (a) of FIG. 9 shows cell proliferation assays (BrdU incorporation) of SMCs explanted from patients heterozygous for an ACTA2 mutation (n=2) proliferate more rapidly than matched control SMCs (n=2). Panel (b) illustrates that myofibroblasts (fibroblasts exposed to TGF-β1 for 72 hours) from patients heterozygous for ACTA2 mutations (n=9) proliferate more rapidly than matched controls (n=10). Data are expressed as means±S.E.M and p values are indicated. Immunoblotting for SM α-actin from the cell lysates confirms that TGF-β1 exposure increased cellular SM α-actin.

Over 100 ACTA1 mutations have been identified and cause three different congenital myopathies, nemaline rod myopathy (NEM), actin myopathy, and intranuclear rod myopathyl^{13, 25}. In contrast, only eight missense ACTAC mutations have been reported, causing either hypertrophic (6 mutations) or dilated (2 mutations) cardiomyopathy²⁶. Characterization of ACTA1 mutations has provided the following genetic evidence for a dominant negative pathogenesis of ACTA1 mutations: the majority of ACTA1 mutations are missense mutations predicted to produce a mutant protein; mutations leading to null alleles are recessively inherited, suggesting that the presence of one nonfunctional allele does not lead to the disease; and hemizygous mice for a null allele of ACTA1 are normal but homozygous animals die shortly after birth^{27, 28}. Only missense ACTA2 mutations were identified, including two mutations also found in ACTA1 in NEM patients, N117T and R258H, implying a similar dominant negative pathogenesis for ACTA2 mutations.

In summary, these data establish that ACTA2 mutations are the most common cause of familial TAAD identify to date, with TGFBR2 and MYH11 responsible for 4% and <2% of the disease, respectively^{6, 14}. Surprisingly, ACTA2 mutations were also linked to LR in some families, reflecting a vascular occlusive aspect to these mutations. Table 7 contains a list of MYH11 mutations identified in patients with vascular diseases other than aortic aneurisms and dissections. Mutations in this disease have been previously reported. These data support that MYH11 mutations also lead to these vascular diseases. Taken together with the MYH11 mutations, there is emerging evidence that the SMC contractile unit plays a critical role in maintaining the structural integrity of the thoracic aorta and therefore preventing TAAD. Mutations in the cardiac contractile proteins cause hypertrophic cardiomyopathy (HCM), an autosomal dominant disease diagnosed clinically by unexplained left ventricular hypertrophy and pathologically by the presence of myocyte hypertrophy, myocyte disarray, and interstitial fibrosis^{26, 26}. Mutations in the cardiac β-myosin heavy chain gene (MYH7) were the first causal mutations identified for HCM and, subsequently, mutations in other components of the thin and thick filaments of the sarcomere, including ACTAC mutations, were identified, leading to the notion that HCM is a disease of contractile sarcomeric proteins^{26, 29, 30}. The present disclosure that mutations in two components of the SMC contractile unit causes familial TAAD raises the possibility that mutations in other components of the SMC contractile unit may be responsible for a portion of the 80% of familial TAAD yet to be explained.

The identification of MYH11 and ACTA2 mutations as causes of TAAD, premature CAD and stroke, along with the SMC cell biology and aortic pathology associated with these mutations, provides insight into various aspects of human vascular disease. These data emphasize the importance of SMC contraction in maintaining proper blood flow and preventing vascular diseases in arteries throughout the body, ranging from the aorta to the dermal arteries. In addition, these mutations potentially identify a novel pathway leading to occlusive vascular diseases even in individuals without significant cardiovascular risk factors. It is proposed that this pathway involves inappropriate SMC proliferation resulting in occlusion of arteries. Furthermore, the broad array of vascular diseases associated with mutations in MYH11 and ACTA2 should modify our approach to identifying genes that predispose individuals to these vascular diseases. Specifically, the concept that a mutation in single gene can cause a variety of vascular diseases within a family, as opposed to a single type of vascular disease, fundamentally alters our approach to studying the genetic basis of vascular diseases. Finally, the identification of single gene mutation leading to various vascular diseases should also improve the clinical risk assessment for vascular diseases based on family history.

### Screening for Mutations to Aid Diagnosis

A sample of genomic DNA is obtained from an individual who is either symptomatic or asymptomatic for a vascular disease is analyzed to detect missense mutations in the individual's ACTA2 gene from chromosome 10. Detection of a missense mutation in the ACTA2 gene is considered to be diagnostic for hyperplastic vasculomyopathy, and indicates increased risk of the individual for developing a stroke, myocardial infarct, aortic aneurysm, aortic dissection, peripheral vascular disease, peripheral neuropathy, bicuspid aortic value, patent ductus arteriosus, cardiac arrhythmia, Sneddon's syndrome and Moyamoya disease. By determining the mutation status of an individual, the physician is better able to screen, diagnose and begin appropriate early treatment of these vascular diseases and, through treatment, prevent premature death or disability. For example, one or more of the following missense mutations may be detected in the individual's ACTA2 gene: R39H, N117T, R149C, R258H, R258C, R118Q, Y135H, V154A and R292G. These mutations are indicative of thoracic aortic aneurysms and dissections (TAAD).

Alternatively, or additionally, the DNA mutational analysis of the individual's MYH11 gene is performed, and the presence and identity of one or more missense mutations in the MYH11 gene is determined. For example, the mutations shown in Table 7 may be used for mutational analysis. Detection of one or more missense mutation in the MYH11 gene is likewise considered to be diagnostic for hyperplastic vasculomyopathy, and indicates increased risk of the individual for developing diverse and diffuse vascular diseases and diseases resulting from vascular complications. Such diseases include stroke, myocardial infarct, thoracic aortic aneurysm and dissection, peripheral vascular disease, peripheral neuropathy, bicuspid aortic value, patent ductus arteriosus, cardiac arrhythmia, Sneddon's syndrome and Moyamoya disease.

Any of a variety of techniques that are known in the art may be used for detecting the above-described missense mutations. One such method of identifying a point mutation in a nucleic acid sequence uses mismatch oligonucleotide mutation detection, also referred to as oligonucleotide mismatch detection. According to this method, a nucleic acid sequence comprising the site to be assayed for the mutation is amplified from a sample, such as by polymerase chain reaction, and a mutation is detected with mutation-specific oligonucleotide probe hybridization of Southern or slot blots, or fluorescence, or micro-arrays, or a combination of any of those techniques.

Single-strand conformation polymorphism (SSCP) is another method that may be used to facilitate detection of polymorphisms, such as single base pair transitions, through mobility shift analysis on a neutral polyacrylamide gel by methods well known in the art. This method is applied subsequent to polymerase chain reaction or restriction enzyme digestion, either of which is followed by denaturation for separation of the strands. The single stranded species are transferred onto a support such as a nylon membrane, and the mobility shift is detected by hybridization with a nick-translated DNA fragment or with RNA. Alternatively, the single stranded product itself is labeled (e.g., radioactively) for identification. Samples manifesting migration shifts in SSCP gels may be analyzed further by other well known methods, such as by DNA sequencing.

Still other applicable methods for genetic screening detect mutations in genomic DNA, cDNA and/or RNA samples obtained from the individual. These methods include denaturing gradient gel electrophoresis (“DGGE”), restriction fragment length polymorphism analysis (“RFLP”), chemical or enzymatic cleavage methods, direct sequencing of target regions amplified by PCR™, single-strand conformation polymorphism analysis (“SSCP”) and other methods well known in the art.

A method of screening for point mutations is based on RNase cleavage of base pair mismatches in RNA/DNA or RNA/RNA heteroduplexes. As used herein, the term “mismatch” is defined as a region of one or more unpaired or mispaired nucleotides in a double-stranded RNA/RNA, RNA/DNA or DNA/DNA molecule. This definition thus includes mismatches due to insertion/deletion mutations, as well as single or multiple base point mutations. U.S. Pat. No. 4,946,773 describes an RNase A mismatch cleavage assay that involves annealing single-stranded DNA or RNA test samples to an RNA probe, and subsequent treatment of the nucleic acid duplexes with RNase A. For the detection of mismatches, the single-stranded products of the RNase A treatment, electrophoretically separated according to size, are compared to similarly treated control duplexes. Samples containing smaller fragments (cleavage products) not seen in the control duplex are scored as positive.

The use of RNase I in mismatch detection assays is also described in the literature, and Promega Biotech markets a kit containing RNase I that is reported to cleave three out of four known mismatches. The use of MutS protein and other DNA-repair enzymes for detection of single-base mismatches has also been described in the literature. Still other alternative methods for detection of deletion, insertion or substitution mutations that may be applied to detection of mutations in ACTA2, MYH11, or other genes that make up a smooth muscle contractile unit are disclosed in U.S. Pat. Nos. 5,849,483, 5,851,770, 5,866,337, 5,925,525 and 5,928,870, the descriptions of such methods are incorporated herein by reference.

### REFERENCES

The following references are cited in the foregoing text:
1. Vandekerckhove J, Weber K. At least six different actins are expressed in a higher mammal: an analysis based on the amino acid sequence of the amino-terminal tryptic peptide. J Mol Biol 1978; 126(4):783-802.
2. McHugh K M, Crawford K, Lessard J L. A comprehensive analysis of the developmental and tissue-specific expression of the isoactin multigene family in the rat. Dev Biol 1991; 148(2):442-458.
3. Fatigati V, Murphy R A. Actin and tropomyosin variants in smooth muscles. Dependence on tissue type. J Biol Chem 1984; 259(23):14383-14388.
4. Schildmeyer L A, Braun R, Taffet G et al. Impaired vascular contractility and blood pressure homeostasis in the smooth muscle alpha-actin null mouse. FASEB J 2000; 14(14):2213-2220.
5. Zhu L, Vranckx R, Khau Van K P et al. Mutations in myosin heavy chain 11 cause a syndrome associating thoracic aortic aneurysm/aortic dissection and patent ductus arteriosus. Nat Genet 2006; 38(3):343-349.
6. Pannu H, Tran-Fadulu V, Papke C L et al. MYH11 mutations result in a distinct vascular pathology driven by insulin-like growth factor 1 and angiotensin II. Hum Mol Genet 2007; 16(20):3453-3462.
7. Pannu H, Avidan N, Tran-Fadulu V, Milewicz D M. Genetic basis of thoracic aortic aneurysms and dissections: potential relevance to abdominal aortic aneurysms. Ann N Y Acad Sci 2006; 1085:242-255.
8. Biddinger A, Rocklin M, Coselli J, Milewicz D M. Familial thoracic aortic dilatations and dissections: a case control study. J Vasc Surg 1997; 25(3):506-511.
9. Loeys B L, Schwarze U, Holm T et al. Aneurysm syndromes caused by mutations in the TGF-beta receptor. N Engl J Med 2006; 355(8):788-798.
10. Guo D, Hasham S, Kuang S Q et al. Familial thoracic aortic aneurysms and dissections: genetic heterogeneity with a major locus mapping to 5q13-14. Circulation 2001; 103 (20):2461-2468.
11. Holmes K C, Angert I, Kull F J, Jahn W, Schroder R R. Electron cryo-microscopy shows how strong binding of myosin to actin releases nucleotide. Nature 2003; 425 (6956):423-427.
12. Otterbein L R, Graceffa P, Dominguez R. The crystal structure of uncomplexed actin in the ADP state. Science 2001; 293(5530):708-711.
13. Sparrow J C, Nowak K J, Durling H J et al. Muscle disease caused by mutations in the skeletal muscle alpha-actin gene (ACTA1). Neuromuscul Disord 2003; 13(7-8):519-531.
14. Pannu H, Fadulu V, Chang J et al. Mutations in transforming growth factor-beta receptor type II cause familial thoracic aortic aneurysms and dissections. Circulation 2005; 112(4):513-520.
15. Gudbjartsson D F, Jonasson K, Frigge M L, Kong A. Allegro, a new computer program for multipoint linkage analysis. Nat Genet 2000; 25(1):12-13.
16. He R, Guo D C, Estrera A L et al. Characterization of the inflammatory and apoptotic cells in the aortas of patients with ascending thoracic aortic aneurysms and dissections. J Thorac Cardiovasc Surg 2006; 131(3):671-678.
17. Poindexter B J. Immunofluorescence deconvolution microscopy and image reconstruction of human defensins in normal and burned skin. J Burns Wounds 2005; 4:e7.
18. Lewis R A, Merin L M. Iris flocculi and familial aortic dissection. Arch Opthalmol 1995; 113(10):1330-1331.
19. Bixler D, Antley R M. Familial aortic dissection with iris anomalies—a new connective tissue disease syndrome? Birth Defects Orig Artic Ser 1976; 12(5):229-234.
20. Finkbohner R, Johnston D, Crawford E S, Coselli J, Milewicz D M. Marfan syndrome. Long-term survival and complications after aortic aneurysm repair. Circulation 1995; 91(3):728-733.
21. Dominguez R. Actin-binding proteins—a unifying hypothesis. Trends Biochem Sci 2004; 29(11):572-578.
22. Klenchin V A, Allingham J S, King R, Tanaka J, Marriott G, Rayment I. Trisoxazole macrolide toxins mimic the binding of actin-capping proteins to actin. Nat Struct Biol 2003; 10(12):1058-1063.
23. Page R, Lindberg U, Schutt C E. Domain motions in actin. J Mol Biol 1998; 280(3):463-474.
24. Small N, Gimona M. The cytoskeleton of the vertebrate smooth muscle cell. Acta Physiol Scand 1998; 164(4):341-348.
25. Nowak K J, Wattanasirichaigoon D, Goebel H H et al. Mutations in the skeletal muscle alpha-actin gene in patients with actin myopathy and nemaline myopathy. Nat Genet 1999; 23(2):208-212.
26. Ahmad F, Seidman J G, Seidman C E. The genetic basis for cardiac remodeling. Annu Rev Genomics Hum Genet 2005; 6:185-216.
27. Nowak K J, Sewry C A, Navarro C et al. Nemaline myopathy caused by absence of alpha-skeletal muscle actin. Ann Neurol 2007; 61(2): 175-184.
28. Crawford K, Flick R, Close L et al. Mice lacking skeletal muscle actin show reduced muscle strength and growth deficits and die during the neonatal period. Mol Cell Biol 2002; 22(16):5887-5896.
29. Geisterfer-Lowrance A A, Kass S, Tanigawa G et al. A molecular basis for familial hypertrophic cardiomyopathy: a beta cardiac myosin heavy chain gene missense mutation. Cell 1990; 62(5):999-1006.
30. Tardiff J C. Sarcomeric proteins and familial hypertrophic cardiomyopathy: linking mutations in structural proteins to complex cardiovascular phenotypes. Heart Fail Rev 2005; 10(3):237-248.

Without further elaboration, it is believed that one skilled in the art can, using the description herein, utilize the present invention to its fullest extent. The embodiments described herein are to be construed as illustrative and not as constraining the remainder of the disclosure in any way whatsoever. While the preferred embodiments of the invention have been shown and described, many variations and modifications thereof can be made by one skilled in the art without departing from the spirit and teachings of the invention. For instance, the present disclosure that mutations in two components of the SMC contractile unit (i.e., ACTA2 and MYH11) causes familial TAAD suggests that mutations in other components of the SMC contractile unit may be responsible for a portion of the 80% of familial TAAD yet to be explained, and may be detected in a manner similar to that described herein with respect to ACTA2. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

TABLE 1
Microsatellite markers at 10q23-24 and 17p11-13

| | | | | |
|---|---|---|---|---|
| Markers | Location | Mas Het | Forward primer | Reward primer |

Chromosome 10p markers

| D10S1765 | chr10: 89591627 | 0.84 | ACACTTACATAGTGCTTTCTGCG | CAGCCTCCCAAAGTTGC |
|---|---|---|---|---|
| D10S1735* | chr10: 90642020 | 0.61 | CCTGATTTGGATGCCATGT | TGACTCAGTGGGGCCTAGA |
| ACTA2_MM1* | chr10: 90666000 | N/A | ATGTCAGACATGAGTTCAGAC | AGGGTACATGTGCACAACGT |
| ACTA2 | chr10: 90,684,813-90,702,491 | | | |
| ACTA2_MM2* | chr10: 90703000 | N/A | CCAGTACTGGTAACCTGATGG | CTCTGTCACCCAGGCTGGAG |
| D10S1739* | chr10: 90802206 | 0.64 | CTGGAAAAACAACAGAGGTG | GCTGTCTAAATCAAGGAATGTC |
| D10S1242* | chr10: 92354750 | 0.86 | CAAGCATACTGTATTAGTTAGGGC | GGACCCCATGATCATGTATG |
| D10S583 | chr10: 94359024 | 0.86 | TCTGACCAAAATACCAAAAGAAC | AGAGACTCCAGATGTTTGATGA |
| D10S1680 | chr10: 95591472 | 0.92 | AGCCTGAGCAACATATCGAA | TCCCGAAGCAGAGAGTACCT |
| D10S2316 | chr10: 96082216 | 0.84 | CATATGGAGAATCACAGTGG | CTGTAGCTTAATATAGCCTC |
| D10S574 | chr10: 97128537 | 0.93 | GTGGGACTCTGTGATTGTG | TGCTTAATGGGGACAGG |
| D10S1709 | chr10: 99475439 | 0.79 | GTGAGTCCAGAATCACCCC | CAGTGGAATGGCTCATTTG |
| D10S1133 | chr10: 102312978 | 0.89 | CCCAAGAGAAACCAAGAGGAT | CCCAGGATACTGACTATTCCC |
| D10S1697 | chr10: 104361865 | 0.77 | GCTGCTTCGATGGAAAC | AACCTGTGTCGGCTGC |
| D10S1268 | chr10: 105551378 | 0.75 | AGCTACCATGTAGATGCTACAATAT | TAAAACCACTCATTCTGATCCT |
| D10S1264 | chr10: 106775670 | 0.77 | ATATCCGATGCCTGTACTGC | AGTTGTGAGGGTGTCAAGAT |
| D10S2469 | chr10: 107510791 | 0.70 | TCTAGCAGTAAGAGTTGTGTCTCC | TTGACAAGGCCATCAAAAC |
| D10S254 | chr10: 107938714 | 0.74 | ACTCCTTCCCATGTAGGTACC | TCCTGTTAAGATGTTACTGAG |
| D10S175 | chr10: 108676535 | 0.70 | CCATAGCCATTCTTCCTCCA | GTGGTGAGAACTCTGAGCCA |
| D10S1663 | chr10: 108736214 | 0.74 | TATCAAGCAATTTACAATCTGTG | AGCCATACCATAGTCAAACTG |
| D10S521 | chr10: 109359518 | 0.80 | CTCCAGAGAAAACAGACCAA | CCTACCATCAATCAACTGAG |
| D10S1120 | chr10: 113310916 | 0.63 | TTTACACTAATCCTTCAGGAA | ACTAGGTTCTATATCTGGCA |

Chromosome 17q markers

| | | | | |
|---|---|---|---|---|
| D17S759 | chr17: 8752451 | 0.73 | TACAGGGATAGGTAGCCGAGAGT | CTTTGGAAAGAATTGTGTTTTATGGT |
| D17S1176 | chr17: 9806252 | 0.86 | ACTTCATATACATATCACGTGC | TCAATGGAGAATTACGATAGTG |
| D17S1148 | chr17: 10588097 | 0.91 | AGGAAGGTTGAAGGCTGCA | TTCCCTGTTTCTGCCTAGG |
| D17S844 | chr17: 16748936 | 0.80 | CCTAACTCAGAGAGAACGAGGC | AGAATAGTATTTCCTGCTGGCG |
| D17S2163 | chr17: 26668501 | 0.70 | TTTTGGACTTCAAGGATGCC | TCCAGATTTGAACACACACACA |
| D17S581 | chr17: 32453478 | 0.75 | CAAGAGTGGAAATTGACCTCG | TAAGATTTTCTCTCAGAGTGCACC |
| D17S1181 | chr17: 34252600 | 0.89 | GACAACAGAGCGAGACTCCC | GCCCAGCCTGTCACTTATTC |
| D17S846 | chr17: 37146709 | 0.83 | TGCATACCTGTACTACTTCAG | TCCTTTGTTGCAGATTTCTTC |
| D17S1185 | chr17: 37807086 | 0.87 | GGTGACAGAACAAGACTCCATC | GGGCACTGCTATGGTTTAGA |
| D17S1146 | chr17: 38207016 | 0.88 | GATCCAAAACTAAAGCTATTATAC | GTAACAGCGTGAGACCTTGTC |
| D17S855 | chr17: 38458269 | 0.82 | GGATGGCCTTTTAGAAAGTGG | ACACAGACTTGTCCTACTGCC |
| D17S1329 | chr17: 38977993 | 0.81 | GACTCTGAAGGTAAAGAGCAA | CTCCCCTGCCTTGGGAGTAG |
| D17S1180 | chr17: 44636240 | 0.85 | GGCAACAAGAGCAAAACTGT | CAAATGGCACGGTAGAAATC |

*Markers closely flanking ACTA2 used to study relatedness of families with recurrent R249C mutations.

TABLE 2
Candidate genes sequenced at the chromosome 10p23-24 locus

| Gene names | Protein names | No. of exons |
|---|---|---|
| ANKRD1 | Ankyrin repeat domain-containing protein 1 | 8 |
| ANKRD2 | Ankyrin repeat domain-containing protein 2 | 9 |
| FER1L3 | Fer-1-like protein 3 (Myoferlin) | 57 |
| LOXL4 | lysyl oxidase-like 4 | 9 |
| PDL1M1 | PDZ and LIM domain 1 (elfin) | 7 |
| PIK3AP1 | phosphoinositide-3-kinase adaptor protein 1 | 19 |
| SLK | STE20-like serine/threonine-protein kinase | 19 |
| ACTA2 | smooth muscle cell alpha-actin | 9 |
| FGF8 | Fibroblast growth factor 8 precursor | 6 |
| HPSE2 | Heparanase-2 | 13 |
| MAEVELD1 | MARVEL domain containing 1 | 2 |
| TNKS2 | Tankyrase-2 | 27 |

TABLE 3
Primers used to sequence ACTA2

| Primer names | Primer sequences |
|---|---|
| ACTA2-eF1 | TGCTGAGGTCCCTATATGGT |
| ACTA2-eR1 | TGCAGGGATTTGGCTGGGTT |
| ACTA2-eF2 | AACCCAGCCTTGGAGGTG |
| ACTA2-eR2 | GTCTATCTCTTTCTGCCCAG |
| ACTA2-eF3 | GAAGAGGAACTTCCCATCTCA |
| ACTA2-eR3 | CTGGCTCACATTGCTCAACT |
| ACTA2-eF4 | GGTTTCAAGTAGCTTCTGGTC |
| ACTA2-eR4 | TGCAGCACAGCAGAGAGAAG |
| ACTA2-eF5 | CTCTGCCCAGAACAGGTCAG |
| ACTA2-eR5 | GTGACGGACTGGAGTTGAGT |
| ACTA2-eF6 | AGGCTCGGAAATTCCCTCTC |
| ACTA2-eR6 | TCCAAGGAGATGATGGGATG |
| ACTA2-eF7 | CTTGAGGGAGAGACTGCAGT |
| ACTA2-eR7 | AGTGACGGTTGCCCCAAGAC |
| ACTA2-eF8 | CTCAGTCCACTGCAAGATCA |
| ACTA2-eR8 | TGGTGACATGCAATTGTGGGT |
| ACTA2-eF9 | TGGTAGAACATCCAGGCTCT |
| ACTA2-eR9 | ACAGGATGGCTCCCTCTAGT |

TABLE 4
Clinical characteristics of patients with ACTA2 mutations

| Variables | n | % | Average Age (range) |
|---|---|---|---|
| Male | 52 | 56% | 42.5 ± 17.8 (8-79 years) |
| Female | 40 | 44% | 40.4 ± 19.6 (3-79 years) |

| Vascular Diseases | | | Ages of Onset (range) | Men | Women |
|---|---|---|---|---|---|
| TAAD | 49 | 53% | 38.3 ± 13.9 (13-67 years) | 37.7 ± 15.0 | 39.4 ± 12.3 |
| Type A | 36 | 39% | 37.8 ± 13.3 (17-67 years) | 37.2 ± 13.5 | 38.8 ± 13.3 |
| Type B | 13 | 14% | 32.4 ± 12.7 (13-53 years ) | 23.4 ± 11.1 | 38.0 ± 10.7 |
| Ascending aneurysm | 18 | 20% | 38.5 ± 14.6 (21-66 years) | 35.3 ± 14.8 | 43.6 ± 13.7 |
| Types A and B (sequential) | 2 | 2% | 44.5 ± 0.7 (44-45 years) | N/A | 44.5 ± 0.7 |
| Type A deaths | 17 | 70% | 40.9 ± 16.2 (17-67 years) | 41.0 ± 18.4 | 40.8 ± 14.6 |

TABLE 5
Clinical characteristics of family members with ACTA2 mutations

| | | | | | Asc | Type | Type | Age of | | | |
|---|---|---|---|---|---|---|---|---|---|---|---|
| Family | Gender | Location | Mutation | Age | Aneu | A | B | Onset | Notes | PDA | BAV |
| 15 | Male | I: 1 | ND | d.67 | | + | − | 67 | Type A dissection (death certificate) | − | − |
| 15 | Female | II: 2 | R292G | 70 | − | − | − | | | − | − |
| 15 | Female | III: 1 | R292G | 53 | + | − | − | 45 | Aotic insufficiency and ascending aortic aneurysm | − | + |
| | | | | | | | | | (4.0 cm, BSA 1.2 m²) surgically repaired | | |
| 15 | Male | III: 2 | R292G | d.46 | − | + | + | 26 | Type A dissection surgically repaired at age 26, | − | − |
| | | | | | | | | | Type B dissection at age 40 | | |
| 15 | Male | III: 3 | R292G | 46 | + | − | − | 36 | Ascending aortic aneurysm (6.5 cm) surgically | − | + |
| | | | | | | | | | repaired | | |
| 20 | Female | II: 1 | ND | d.49 | − | − | − | | Death due to coronary artery disease (death certificate) | − | − |
| 20 | Female | II: 3 | R149C | 71 | − | − | − | | | − | − |
| 20 | Female | II: 4 | R149C | 64 | + | + | + | 45 | Type A dissection with ascending aortic aneurysm | − | − |
| | | | | | | | | | (4.5 cm) surgically repaired at age 45, Type B | | |
| | | | | | | | | | dissection at age 53 | | |
| 20 | Male | II: 7 | R149C | 56 | − | − | − | | | − | − |
| 20 | Male | III: 1 | R149C | 49 | + | + | − | 29 | Type A dissection with ascending aortic aneurysm | − | − |
| | | | | | | | | | (6.0-7.0 cm) surgically repaired at age 29 | | |
| 20 | Female | III: 3 | ND | d.27 | + | + | − | 27 | Type A dissection (autopsy report) | − | − |
| 39 | Male | II: 2 | N117T | 71 | − | + | − | 53 | Type A dissection surgically repaired | − | − |
| 39 | Male | II: 10 | N117T | 56 | − | − | − | 56 | | − | − |
| 39 | Male | III: 6 | N117T | 36 | | + | − | 29 | Type A dissection surgically repaired | − | − |
| 41 | Male | I: 1 | ND | d.48 | | + | − | 48 | Type A dissection (death certificate) | − | − |
| 41 | Male | II: 2 | R149C | d.41 | | | | | Death due to coronary artery disease (autopsy report) | − | − |
| 41 | Male | II: 4 | R149C | 43 | − | − | + | 41 | | − | − |
| 41 | Female | II: 7 | R149C | d.29 | | + | − | 29 | Type A dissection (death certificate) | − | − |
| 41 | Male | II: 8 | R149C | 31 | − | − | − | | | − | − |
| 41 | Male | III: 1 | R149C | 19 | − | − | − | | | − | − |
| 41 | Male | III: 2 | R149C | 12 | − | − | − | | | − | − |
| 105 | Female | I: 2 | ND | d.28 | | + | | 28 | Type A dissection (death certificate) | − | − |
| 105 | Male | II: 1 | ND | d.18 | | + | | 18 | Type A dissection (death certificate) | − | − |
| 105 | Female | II: 3 | R258H | 48 | | + | + | 36 | Type A dissection surgically repaired | − | − |
| 105 | Female | II: 4 | R258H | 48 | + | − | − | 45 | Ascending aortic aneurysm (4.9 cm) surgically | − | − |
| | | | | | | | | | repaired | | |
| 105 | Female | III: 2 | R258H | 16 | − | − | − | | | + | − |
| 105 | Female | III: 3 | R258H | 23 | − | − | − | | | − | − |
| 105 | Male | III: 4 | R258H | 20 | − | − | + | 16 | Type B dissection surgically repaired | − | − |
| 133 | Male | I: 1 | V154A | 65 | − | − | − | | | − | − |
| 133 | Female | II: 1 | V154A | 44 | − | − | − | | | − | − |
| 133 | Female | II: 2 | V154A | 42 | | + | − | 31 | Type A dissection surgically repaired | − | − |
| 133 | Male | II: 3 | V154A | 40 | | + | − | 36 | Type A dissection surgically repaired | − | − |
| 166 | Male | I: 1 | ND | d.55 | | + | − | 55 | Type A dissection (death certificate) | | |
| 166 | Male | II: 2 | Y135H | 56 | + | + | − | 52 | Type A dissection with ascending aortic aneurysm | − | − |
| | | | | | | | | | (6.0 cm) surgically repaired | | |
| 166 | Female | II: 3 | Y135H | 54 | − | − | − | | | − | − |
| 166 | Female | II: 4 | Y135H | 51 | − | − | − | | | − | − |
| 174 | Female | I: 2 | R118Q | 79 | + | + | − | 55 | Type A dissection and ascending aortic aneurysm | − | − |
| | | | | | | | | | (5.3 cm) surgically repaired | | |
| 174 | Female | II: 4 | R118Q | 53 | − | − | + | 49 | | − | − |
| 174 | Male | II: 6 | R118Q | 47 | + | + | − | 24 | Type A dissection with ascending aortic aneurysm | − | − |
| | | | | | | | | | (7.0 cm) surgically repaired | | |
| 313 | Male | I: 1 | ND | d.76 | + | − | − | 66 | Aortic insufficiency and ascending aortic aneurysm | − | + |
| | | | | | | | | | surgically repaired | | |
| 313 | Female | II: 1 | T353A | 53 | | | | | | − | − |
| 313 | Male | II: 2 | T353A | 51 | + | + | − | 49 | Type A dissection with ascending aortic aneurysm | − | − |
| | | | | | | | | | (5.6 cm) surgically repaired | | |
| 313 | Male | II: 3 | T353A | d.45 | − | − | − | | Death due to coronary artery disease (death certificate) | − | − |
| 313 | Female | II: 6 | T353A | 45 | − | − | − | | | − | − |
| 313 | Male | III: 1 | T353A | d.17 | + | + | − | 17 | Type A dissection with ascending aortic aneurysm | − | − |
| | | | | | | | | | (10.0 cm) (autopsy report) | | |
| 313 | Female | III: 2 | T353A | 16 | − | − | − | | | − | − |
| 313 | Male | III: 3 | T353A | 15 | − | − | − | | | − | − |
| 313 | Female | III: 4 | T353A | 13 | − | − | − | | | − | − |
| 313 | Male | III: 5 | T353A | 7 | − | − | − | | | − | − |
| 327 | Male | II: 1 | R149C | d.67 | − | − | − | 57 | Type A dissection surgically repaired at age 57 | − | − |
| 327 | Female | II: 4 | R149C | 77 | − | − | − | | | − | − |
| 327 | Female | II: 8 | R149C | d.51 | − | + | − | 51 | Type A dissection (medical records) | − | − |
| 327 | Male | III: 2 | R149C | 58 | − | − | − | | | − | − |
| 327 | Male | III: 3 | R149C | 57 | − | − | − | | | − | − |
| 327 | Male | III: 5 | R149C | 55 | − | − | − | | | − | − |
| 327 | Female | III: 8 | R149C | 51 | − | − | + | 48 | Type B dissection surgically repaired | − | − |
| 327 | Male | III: 11 | R149C | 46 | − | − | − | 44 | | − | − |
| 327 | Male | III: 13 | R149C | 44 | − | − | − | | | − | − |
| 327 | Female | III: 15 | R149C | 49 | − | − | + | 47 | | − | − |
| 327 | Female | III: 17 | R149C | 45 | − | − | − | | | − | − |
| 327 | Male | III: 19 | R149C | 37 | + | + | − | 36 | Type A dissection with ascending aortic aneurysm | − | − |
| | | | | | | | | | (6.0 cm) surgically repaired | | |
| 327 | Male | III: 20 | ND | d.24 | | + | − | 24 | Type A dissection (death certificate) | − | − |
| 327 | Female | IV: 4 | R149C | 31 | − | − | + | 28 | | − | − |
| 327 | Male | IV: 5 | R149C | 28 | + | + | − | 26 | Type A dissection with ascending aortic aneurysm | − | − |
| | | | | | | | | | (4.6 cm) surgically repaired | | |
| 327 | Male | IV: 6 | R149C | 23 | − | − | − | | | − | − |
| 327 | Male | IV: 7 | R149C | 30 | − | − | − | | | − | − |
| 327 | Male | IV: 9 | R149C | 22 | − | − | − | | | − | − |
| 327 | Female | IV: 10 | R149C | 27 | − | − | − | | | − | − |
| 327 | Female | IV: 12 | R149C | 20 | − | − | − | | | − | − |
| 327 | Female | IV: 13 | R149C | 19 | − | − | − | | | − | − |
| 327 | Male | IV: 14 | R149C | 15 | − | − | + | 13 | Type B dissection complicated by rupture | − | − |
| | | | | | | | | | surgically repaired | | |
| 349 | Male | II: 1 | ND | d.37 | | + | − | 37 | Type A dissection (death certificate) | − | − |
| 349 | Male | II: 3 | R149C | 48 | − | − | − | | | − | − |
| 349 | Female | III: 1 | R149C | 28 | − | − | − | | | − | − |
| 349 | Male | III: 3 | R149C | 28 | + | + | − | 21 | Type A dissection with “mildly” dilated aorta | − | + |
| | | | | | | | | | surgically repaired | | |
| 349 | Male | III: 4 | R149C | 26 | − | − | − | | | − | − |
| 349 | Male | III: 5 | R149C | 23 | − | − | + | 21 | Type B dissection with progression to descending | − | − |
| | | | | | | | | | aneurysm (6.3 cm) surgically repaired | | |
| 370 | Female | I: 2 | ND | d.56 | | + | − | 56 | Type A dissection (death certificate) | − | − |
| 370 | Female | II: 2 | ND | d.44 | | + | + | 30 | Chronic type A dissection (death certificate) | − | − |
| 370 | Male | II: 3 | ND | d.43 | | + | − | 43 | Type A dissection (autopsy report) | − | − |
| 370 | Female | II: 6 | ND | d.28 | | + | − | 28 | Type A dissection (death certificate) | − | − |
| 370 | Female | III: 2 | R149C | 47 | − | − | + | 21 | Type B dissection complicated by rupture | − | − |
| | | | | | | | | | surgically repaired | | |
| 370 | Male | III: 4 | R149C | 46 | − | − | − | | | − | − |
| 370 | Male | III: 7 | R149C | 44 | | + | − | 41 | Type A dissection surgically repaired | − | − |
| 377 | Male | I: 1 | R258C | 74 | | + | − | 53 | Type A dissection surgically repaired | + | − |
| 377 | Male | II: 1 | R258C | 53 | − | − | − | | | + | − |
| 377 | Female | III: 3 | R258C | 27 | + | + | − | 25 | Type A dissection with ascending aortic aneurysm | + | − |
| | | | | | | | | | (7.1 cm) surgically repaired | | |
| 377 | Female | IV: 2 | R258C | 7 | − | − | − | | | + | − |
| 377 | Female | IV: 3 | R258C | 3 | − | − | − | | | + | − |
| 390 | Female | II: 2 | ND | d.63 | + | + | − | 63 | Type A dissection with ascending aortic aneurysm | − | − |
| | | | | | | | | | (4.5-5.0 cm) (medical records) | | |
| 390 | Male | II: 3 | ND | d.60 | | + | − | 40 | Type A dissection surgically repaired | − | − |
| 390 | Male | III: 5 | R258C | 49 | + | + | − | 32 | Type A dissection with ascending aortic aneurysm | − | − |
| | | | | | | | | | (6.0 cm) surgically repaired | | |
| 390 | Male | IV: 5 | R258C | d.8 | − | − | − | | Died at age 8 of recurrent stroke | − | − |

TABLE 6

| | | | | | | | | # of | |
|---|---|---|---|---|---|---|---|---|---|
| | | | | | | | | controls | |
| | | | | | Control | | | have the | |
| Sample ID | Diseases | Age | Gender | Race | Genotype | Genotypes | Locations | alterations | Alteration ID |
| HH0000533 | Stroke | 40 | F | C | CC | CA+ | 5UTR | | TA_9642350_114_SD3_1* |
| HH0000879 | Stroke | 60 | F | B | CC | CA+ | 5UTR | | TA_9642350_114_SD3_1* |
| HH0000944 | Stroke | 38 | F | B | CC | AA | 5UTR | | TA_9642350_114_SD3_1* |
| HH0000992 | Stroke | 57 | M | ASIAN | CC | CA+ | 5UTR | | TA_9642350_114_SD3_1* |
| HH0001037 | Stroke | 53 | M | O | CC | CA+ | 5UTR | | TA_9642350_114_SD3_1* |
| HH0001061 | Stroke | 60 | F | B | CC | CA+ | 5UTR | | TA_9642350_114_SD3_1* |
| HH0001097 | Stroke | 44 | M | H | CC | CA+ | 5UTR | | TA_9642350_114_SD3_1* |
| HH0001354 | Stroke | 41 | M | H | CC | CA+ | 5UTR | | TA_9642350_114_SD3_1* |
| HH0001384 | Stroke | 53 | M | H | CC | CA+ | 5UTR | | TA_9642350_114_SD3_1* |
| HH0001645 | Stroke | 51 | F | H | CC | CA+ | 5UTR | | TA_9642350_114_SD3_1* |
| HH0001660 | Stroke | 57 | F | B | CC | CA+ | 5UTR | | TA_9642350_114_SD3_1* |
| MG6073 | Sporadic | 72 | F | B | GG | GC+ | promoter −79bp | 1 | TA_9642350_219_SD3_1** |
| | TAAD | | | | | | | | |
| MG6071 | Sporadic | 19 | M | C | TT | TG_{—} | intron1 (e1 + 13) | 2 | TA_9642350_86_SD3_1** |
| | TAAD | | | | | | | | |
| MG6441 | Sporadic | 57 | M | C | TT | TG_{—} | intron1 (e1 + 13) | | TA_9642350_86_SD3_1** |
| | TAAD | | | | | | | | |
| TAA154_2187 | Familial TAAD | 66 | M | C | TT | TG_{—} | intron1 (e1 + 13) | | TA_9642350_86_SD3_1** |
| TAA164_2002 | Familial TAAD | 82 | M | B | TT | TG_{—} | intron1 (e1 + 13) | | TA_9642350_86_SD3_1** |
| HH0001085 | Stroke | 52 | F | B | TT | TG | intron2 (e2 + 56) | | TA_9642353_37_SD3_1* |
| HH0001368 | Stroke | 47 | F | B | TT | TG+ | intron2 (e2 + 56) | | TA_9642353_37_SD3_1* |
| HH0001398 | Stroke | 46 | M | B | TT | TG | intron2 (e2 + 56) | | TA_9642353_37_SD3_1* |
| MG4127 | Sporadic | 76 | F | C | TT | TG+ | intron2 (e2 + 56) | | TA_9642353_37_SD3_1* |
| | TAAD | | | | | | | | |
| MG5632 | Sporadic | 65 | M | C | TT | TG+ | intron2 (e2 + 56) | | TA_9642353_37_SD3_1* |
| | TAAD | | | | | | | | |
| MG6833 | Sporadic | 60 | M | C | TT | TG_{—} | intron2 (e2 + 56) | | TA_9642353_37_SD3_1* |
| | TAAD | | | | | | | | |
| TAA243_5079 | Familial TAAD | 68 | M | C | TT | GG | intron2 (e2 + 56) | | TA_9642353_37_SD3_1* |
| TS0005858 | CAD | | | | TT | TG | intron2 (e2 + 56) | | TA_9642353_37_SD3_1* |
| HH0000944 | Stroke | 38 | F | B | TT | TC | intron4 (e4 + 65) | 1 | TA_9642359_21_SD3_1** |
| TS0002988 | CAD | | | | TT | TC | intron4 (e4 + 65) | | TA_9642359_21_SD3_1** |
| TS0005104 | CAD | | | | TT | TC | intron4 (e4 + 65) | | TA_9642359_21_SD3_1** |
| MG5642 | Sporadic | 60 | M | H | CC | CA+ | intron3 (e4 − 52) | | TA_9642359_248_SD3_1* |
| | TAAD | | | | | | | | |
| TS0002676 | CAD | | | | CC | CT+ | exon5 (synon) | | TA_9642362_136_SD3_1* |
| MG6865 | Sporadic | 50 | M | C | CC | CT | intron5 (e5 + 73) | | TA_9642362_26_SD3_1* |
| | TAAD | | | | | | | | |
| HH0000627 | Stroke | 50 | M | C | CC | CT | intron5 (e5 + 65) | 2 | TA_9642362_34_SD3_1** |
| HH0000853 | Stroke | 55 | M | C | CC | CT | intron5 (e5 + 65) | | TA_9642362_34_SD3_1** |
| HH0000896 | Stroke | 54 | M | C | CC | CT | intron5 (e5 + 65) | | TA_9642362_34_SD3_1** |
| HH0001268 | Stroke | 59 | M | C | CC | | intron5 (e5 + 65) | | TA_9642362_34_SD3_1** |
| HH0001380 | Stroke | 52 | M | C | CC | CT | intron5 (e5 + 65) | | TA_9642362_34_SD3_1** |
| HH0001390 | Stroke | 44 | M | B | CC | CT | intron5 (e5 + 65) | | TA_9642362_34_SD3_1** |
| HH0001602 | Stroke | 54 | M | H | CC | CT | intron5 (e5 + 65) | | TA_9642362_34_SD3_1** |
| HH0001625 | Stroke | 50 | M | C | CC | CT | intron5 (e5 + 65) | | TA_9642362_34_SD3_1** |
| HH0001637 | Stroke | 37 | M | ASIAN | CC | CT | intron5 (e5 + 65) | | TA_9642362_34_SD3_1** |
| HH0001655 | Stroke | 48 | M | C | CC | CT | intron5 (e5 + 65) | | TA_9642362_34_SD3_1** |
| MG3992 | Sporadic | 74 | F | C | CC | CT | intron5 (e5 + 65) | | TA_9642362_34_SD3_1** |
| | TAAD | | | | | | | | |
| MG5172 | Sporadic | 73 | F | C | CC | CT | intron5 (e5 + 65) | | TA_9642362_34_SD3_1** |
| | TAAD | | | | | | | | |
| MG6196 | Sporadic | 20 | M | O | CC | CT | intron5 (e5 + 65) | | TA_9642362_34_SD3_1** |
| | TAAD | | | | | | | | |
| MG6311 | Sporadic | 56 | F | O | CC | CT | intron5 (e5 + 65) | | TA_9642362_34_SD3_1** |
| | TAAD | | | | | | | | |
| MG6897 | Sporadic | 66 | M | C | CC | CT | intron5 (e5 + 65) | | TA_9642362_34_SD3_1** |
| | TAAD | | | | | | | | |
| TS0002461 | CAD | | | | CC | CT | intron5 (e5 + 65) | | TA_9642362_34_SD3_1** |
| TS0002869 | CAD | | | | CC | CT | intron5 (e5 + 65) | | TA_9642362_34_SD3_1** |
| TS0005676 | CAD | | | | CC | CT | intron5 (e5 + 65) | | TA_9642362_34_SD3_1** |
| HH0000905 | Stroke | 52 | M | C | GG | GA | intron5 (e6 − 76) | 3 | TA_9642365_329_SD3_1** |
| MG5980 | Sporadic | 68 | F | C | GG | GA | intron5 (e6 − 76) | | TA_9642365_329_SD3_1** |
| | TAAD | | | | | | | | |
| HH0000952 | Stroke | 41 | F | C | GG | GA_{—} | intron5 (e6 − 76) | | TA_9642365_329_SD3_2** |
| HH0001637 | Stroke | 37 | M | ASIAN | GG | AA | intron5 (e6 − 76) | | TA_9642365_329_SD3_3** |
| HH0000100 | Stroke | 44 | M | C | TT | TC | intron7 (e7 + 81) | 3 | TA_9642368_21_SD3_1** |
| HH0000717 | Stroke | 55 | M | C | TT | TC | intron7 (e7 + 81) | | TA_9642368_21_SD3_1** |
| HH0000794 | Stroke | 50 | M | C | TT | TC | intron7 (e7 + 81) | | TA_9642368_21_SD3_1** |
| HH0001003 | Stroke | 53 | M | O | TT | TC | intron7 (e7 + 81) | | TA_9642368_21_SD3_1** |
| | | | | (C or H) | | | | | |
| HH0001005 | Stroke | 53 | F | C | TT | TC | intron7 (e7 + 81) | | TA_9642368_21_SD3_1** |
| HH0001064 | Stroke | 49 | M | H | TT | TC | intron7 (e7 + 81) | | TA_9642368_21_SD3_1** |
| HH0001277 | Stroke | 45 | M | B | TT | TC | intron7 (e7 + 81) | | TA_9642368_21_SD3_1** |
| HH0001396 | Stroke | 26 | M | C | TT | TC | intron7 (e7 + 81) | | TA_9642368_21_SD3_1** |
| MG4956 | Sporadic | 66 | M | C | TT | TC | intron7 (e7 + 81) | | TA_9642368_21_SD3_1** |
| | TAAD | | | | | | | | |
| MG7063 | Sporadic | 37 | M | Other | TT | TC | intron7 (e7 + 81) | | TA_9642368_21_SD3_1** |
| | TAAD | | | pacific | | | | | |
| | | | | islander | | | | | |
| TS0002282 | CAD | | | | TT | TC | intron7 (e7 + 81) | | TA_9642368_21_SD3_1** |
| TS0002409 | CAD | | | | TT | TC | intron7 (e7 + 81) | | TA_9642368_21_SD3_1** |
| TS0004045 | CAD | | | | TT | TC | intron7 (e7 + 81) | | TA_9642368_21_SD3_1** |
| TS0004842 | CAD | | | | TT | TC | intron7 (e7 + 81) | | TA_9642368_21_SD3_1** |
| TS0005175 | CAD | | | | TT | TC | intron7 (e7 + 81) | | TA_9642368_21_SD3_1** |
| TS0005804 | CAD | | | | TT | TC | intron7 (e7 + 81) | | TA_9642368_21_SD3_1** |
| TS0006261 | CAD | | | | TT | TC | intron7 (e7 + 81) | | TA_9642368_21_SD3_1** |
| HH0000315 | Stroke | 53 | M | C | GG | GT+ | intron8 (e8 + 56) | | TA_9642371_53_SD3_1* |
| HH0000956 | Stroke | 51 | F | C | CC | CA+ | 3UTR | 2 | TA_9642374_129_SD3_1** |
| | | | | | | | (TAA + 104) | | |
| MG4683 | Sporadic | 44 | F | C | CC | CA+ | 3UTR | | TA_9642374_129_SD3_1** |
| | TAAD | | | | | | (TAA + 104) | | |
| HH0000949 | Stroke | 48 | F | B | CC | CT | 65bp after | | TA_9642374_23_SD3_1* |
| | | | | | | | exon9 | | |
| HH0001015 | Stroke | 51 | M | B | CC | CT | 65bp after | | TA_9642374_23_SD3_1* |
| | | | | | | | exon9 | | |
| HH0001277 | Stroke | 45 | M | B | CC | CT | 65bp after | | TA_9642374_23_SD3_1* |
| | | | | | | | exon9 | | |
| HH0001390 | Stroke | 44 | M | B | CC | CT | 65bp after | | TA_9642374_23_SD3_1* |
| | | | | | | | exon9 | | |
| MG5642 | Sporadic | 60 | M | H | CC | CT | 65bp after | | TA_9642374_23_SD3_1* |
| | TAAD | | | | | | exon9 | | |
| MG5916 | Sporadic | 78 | M | C | CC | CT | 65bp after | | TA_9642374_23_SD3_1* |
| | TAAD | | | | | | exon9 | | |
| MG6907 | Sporadic | 77 | F | C | CC | CT | 65bp after | | TA_9642374_23_SD3_1* |
| | TAAD | | | | | | exon9 | | |
| MG5142 | Sporadic | 49 | M | C | CC | CT_{—} | intron8 (e9 − 36) | | TA_9642374_414_SD3_1* |
| | TAAD | | | | | | | | |
| MG7004 | Sporadic | 65 | F | C | CC | CT+ | intron8 (e9 − 36) | | TA_9642374_414_SD3_1* |
| | TAAD | | | | | | | | |

*Not found in control
**Found in control

TABLE 7

| | | | Vascular | |
|---|---|---|---|---|
| Patient # | MYH11 mutation | Ethnicity | disease | Comments |
| HH0001373 | R163W | Cauc | stroke | |
| HH0001400 | R247C | Cauc | CAD | R247C (MYH11), which in MYH7 is equivalent to |
| | | | | R249Q (HCM) Rosenzweig (1991) N Engl J Med |
| | | | | 325, 1753 |
| HH0000174 | R501H | Cauc | stroke | |
| HH000471 | R669C | Hisp | stroke | R669C (MYH11), which in MYH7 is equivalent to |
| | | | | R663C (HCM) Song (2005) Clin Chim Acta 351, 209 |
| HH000441 | E1742D | Other | stroke | Meets Moyamoya criteria |
| TS0005773 | E908D | Cauc | CAD | E908D (MYH11), which in MYH7 is equivalent to |
| | | | | E903K (HCM) Van Driest (2004) J Am Coll Cardiol |
| | | | | 44, 602 |
| SGVD117 | H1201D | Asian (Japanese) | MMD | |
| SGVD156 | A1204V(prob benign), | Asian (Chinese) | MMD | |
| | D1579N | | | |
| SGVD208 | E520A | Cauc | MMD | |
| MG8723 | R669C | Cauc/Native American | MMD | R669C (MYH11), which in MYH7 is equivalent to |
| | | | | R663C (HCM) Song (2005) Clin Chim Acta 351, 209 |
| MG8714 | K1088E | Asian (Korean) | MMD | |
| MG8760 | E1833D | Cauc | MMD | |
| MG8707 | N1899S | Asian (Korean) | MMD | |
| MG8737 | P1933Q | Cauc | MMD | |
| MG8713 | R1535Q | Hisp | MMD | |
| MG8750 | N3055 | Asian (Vietnamese) | MMD | |
| MG8753 | A334S | Asian (Chinese) | MMD | |
| MG8752 | (just outside exon) | Asian (Korean- | MMD | |
| | | Hawaiian) | | |
| MG8693 | N7025, R1058Q | unknown | aneurysm | |

What is claimed is:

1. A method of detecting in an individual an increased risk of hyperplastic vasculomyopathy, or a vascular disease resulting therefrom, comprising:
detecting in a DNA genome sample from an individual a missense mutation in a gene which is a component of a smooth muscle cell contractile unit, wherein the presence of a missense mutation in said gene indicates an increased risk of hyperplastic vasculomyopathy in said individual.

2. The method of claim 1, wherein said detecting comprises detecting in said individual a missense mutation in the ACTA2 nucleic acid sequence or in the MYH11 nucleic acid sequence, wherein the presence of a missense mutation in either ACTA2 or MYH11 indicates an increased risk of hyperplastic vasculomyopathy in said individual.

3. The method of claim 1, wherein detecting said missense mutation comprises:
determining in said sample the nucleotide sequence of said gene; and
comparing said sequence to a panel of control sequences to detect any missense mutations in said gene.

4. The method of claim 1, wherein said detecting comprises oligonucleotide mismatch detection.

5. The method of claim 1, wherein said detecting comprises detecting single-strand conformation polymorphism in said gene.

6. The method of claim 1, wherein said control sequences are representative of the same gene in a group of individuals who are free of vascular disease or who are at low risk of developing hyperplastic vasculomyopathy.

7. The method of claim 1, wherein said gene is ACTA2 and said missense mutation is selected from the group consisting of R39H, N117T, R149C, R258H, R258C, T353N, R118Q, Y135H, V154A and R292G.

8. The method of claim 1, wherein said vascular disease is selected from the group consisting of stroke, myocardial infarct, thoracic aortic aneurysm, thoracic aortic dissection, peripheral vascular disease, peripheral neuropathy, bicuspid aortic value, patent ductus arteriosus, cardiac arrhythmia, Sneddon's syndrome and Moyamoya disease.

9. The method of claim 8, wherein said vascular disease comprises thoracic aortic aneurysm or thoracic aortic dissection.

10. The method of claim 1, wherein said mutation is selected from the group consisting of R29H, P72Q, G160D, R185Q, R212Q, P245H, 1250L and T326N.

11. The method of claim 1 wherein the gene is β-myosin heavy chain (MYH11).
